(19) United States
(12) Patent Application Publication
(10) Pub. No.: US 2010/0183075 A1
(43) Pub. Date: Jul. 22, 2010

(54) IMAGE PROCESSING METHOD, IMAGE PROCESSING APPARATUS AND COMPUTER READABLE STORAGE MEDIUM

(75) Inventors: Eiji Furukawa, Saitama-shi (JP); Masatoshi Okutomi, Tokyo (JP); Masayuki Tanaka, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignees: Olympus Corporation, Tokyo (JP); TOKYO INSTITUTE OF TECHNOLOGY, Tokyo (JP)

(21) Appl. No.: 12/689,443

(22) Filed: Jan. 19, 2010

Related U.S. Application Data
(63) Continuation of application No. PCT/JP2008/063091, filed on Jul. 15, 2008.

(30) Foreign Application Priority Data
Jul. 19, 2007 (JP) 2007-188368

(51) Int. Cl. H04N 11/02; G06K 9/36

(52) U.S. Cl. 375/240.16; 382/236; 375/E07.123; 375/E07.104

(57) ABSTRACT

An image processing method includes: a frame selection step; a motion vector calculation step for calculating a motion vector value from one frame image to another frame image by tracking each pixel of one or a plurality of frame images; and a motion vector correction step for calculating an imaginary motion vector when a motion vector that can be tracked to a tracking destination pixel corresponding to a pixel tracked up to a midway point does not exist due to an encoding type of a block including the pixel tracked up to the midway point.

### CROSS-REFERENCE TO RELATED APPLICATIONS

This application is a continuation of International Patent Application No. PCT/JP2008/063091, filed on Jul. 15, 2008, which claims the benefit of Japanese Patent Application No. JP2007-188368, filed on Jul. 19, 2007, which is incorporated by reference as if fully set forth.

### FIELD OF THE INVENTION

This invention relates to image processing, and more particularly to image processing with which position alignment and so on can be performed between frame images using encoded moving image data recorded with inter-frame image motion information.

### BACKGROUND OF THE INVENTION

In a conventional motion vector conversion method employing encoded moving image data, motion vector conversion is performed in each block during bit stream conversion from interlaced scanning MPEG2 to progressive scanning MPEG4, frame rate conversion is performed during conversion from interlaced to progressive, and an original MPEG2 frame is discarded (see page 1 and FIG. 19 of JP2002-252854A). In this case, a motion vector value from a post-frame adjacent to the discarded frame to an adjacent pre-frame is deter mined on the basis of an inter-block motion vector corresponding to the post-frame adjacent to the discarded frame and recorded as a new motion vector value of the block corresponding to the adjacent post-frame.

In JP2002-252854A, when a motion vector exists between the discarded frame and the adjacent pre-frame, a value obtained by accumulating a motion vector from the adjacent post-frame to the discarded frame and a motion vector from the discarded frame to the adjacent pre-frame is set as the new motion vector value, and when a motion vector does not exist between the discarded frame and the adjacent pre-frame, a value obtained by converting the motion vector from the adjacent post-frame to the discarded frame through expansion taking into account a time from the discarded frame to the adjacent pre-frame is set as the new motion vector value.

### DISCLOSURE OF THE INVENTION

According to an aspect of this invention, an image processing method that uses an inter-frame image motion vector recorded in encoded moving image data comprises: a frame selection step for selecting a plurality of frames from frame images obtained by decoding the encoded moving image data; a motion vector calculation step for calculating a motion vector value from one frame image to another frame image of the plurality of frame images selected in the frame selection step by tracking each pixel of one or a plurality of frame images using the motion vector recorded in the encoded moving image data; and a motion vector correction step for calculating an imaginary motion vector from a pixel tracked up to a midway point to a tracking destination pixel corresponding to the pixel tracked up to the midway point when a motion vector that can be tracked to the tracking destination pixel does not exist in the motion vector calculation step due to an encoding type of a block including the pixel tracked up to the midway point.

According to another aspect of this invention, an image processing apparatus that uses an inter-frame image motion vector recorded in encoded moving image data comprises: a frame selection unit which selects a base frame and a reference frame from frame images obtained by decoding the encoded moving image data; and a motion vector calculation unit which calculates a motion vector value from the reference frame to the base frame by accumulating the motion vector recorded in the encoded moving image data taking direction into account so as to track each pixel of one or a plurality of frame images, wherein the motion vector calculation unit includes a motion vector correction unit which calculates an imaginary motion vector from a pixel tracked up to a midway point to a tracking destination pixel corresponding to the pixel tracked up to the midway point when a motion vector that can be tracked to the tracking destination pixel does not exist due to an encoding type of a block including the pixel tracked up to the midway point.

According to a further aspect of this invention, in a computer readable storage medium stored with a computer program for causing a computer to execute image processing that uses an inter-frame image motion vector recorded in encoded moving image data, the computer program comprises: a frame selection step for selecting a plurality of frames from frame images obtained by decoding the encoded moving image data; a motion vector calculation step for calculating a motion vector value from one frame image to another frame image of the plurality of frame images selected in the frame selection step by tracking each pixel of one or a plurality of frame images using the motion vector recorded in the encoded moving image data; and a motion vector correction step for calculating an imaginary motion vector from a pixel tracked up to a midway point to a tracking destination pixel corresponding to the pixel tracked up to the midway point when a motion vector that can be tracked to the tracking destination pixel does not exist in the motion vector calculation step due to an encoding type of a block including the pixel tracked up to the midway point.

Embodiments and advantages of this invention will be described in detail below with reference to the attached figures.

### BRIEF DESCRIPTION OF THE DRAWINGS

FIG. 1 is a block diagram showing the constitution of an image processing apparatus for implementing an image processing method according to a first embodiment of this invention.

FIG. 2 is a flowchart showing processing performed in the image processing method according to the first embodiment.

FIG. 3 is a block diagram showing the constitution of an MPEG4 decoding processing block.

FIG. 4 is a view showing a specification method employed by a user to specify a base frame and a reference frame during frame specification according to the first embodiment.

FIG. 5 is a view showing an outline of motion vector calculation processing employed during position alignment processing according to the first embodiment.

FIG. 6 is a flowchart showing the content of motion vector calculation processing shown in FIG. 2.

FIG. 7 is a flowchart showing the content of the motion vector calculation processing shown in FIG. 2.

FIG. 8 is a view showing a method of updating a motion vector value during motion vector value updating processing.

FIG. 9 is a view showing the processing content of processing (1) to (9) in FIG. 6.

FIG. 10 is a flowchart showing the content of motion vector correction processing.

FIGS. 11A and 11B are views showing examples of a predicted direction during motion compensation and a direction of a motion vector included in each frame as a result of the motion compensation.

FIG. 12 is a view showing a macroblock encoding mode of each frame encoding type and a motion vector included in each macroblock in each mode.

FIG. 13 is a view showing an example of tracking in the motion vector calculation processing.

FIG. 14 is a view showing another example of tracking in the motion vector calculation processing.

FIGS. 15A-15C are views showing methods of searching for a pixel and a motion vector corresponding to a subject pixel in the example of FIG. 14.

FIGS. 16A-16D are views showing a case in which motion vector correction processing is required in the motion vector calculation processing and correction methods employed in the motion vector correction processing.

FIGS. 17A-17D are views showing examples of weighting coefficient settings in the motion vector correction processing.

FIGS. 18A-18D are views showing direction differentiation and orientation differences during the weighting coefficient setting of the motion vector correction processing.

FIG. 19 is a view showing an example in which a pixel corresponding to a subject pixel deviates from an image area during tracking.

FIGS. 20A and 20B are views illustrating causes of a situation in which the pixel corresponding to the subject pixel deviates from the image area.

FIG. 21 is a flowchart showing an algorithm of position alignment processing performed by a position alignment processing unit and high-resolution image generation processing performed by a high-resolution image generation unit 18.

FIG. 22 is a block diagram showing a constitutional example of the high-resolution image generation unit.

FIG. 23 is a view showing a correction method employed during motion vector correction processing according to a second embodiment of this invention.

FIG. 24 is a view showing a correction method employed during motion vector correction processing according to a third embodiment of this invention.

FIG. 25 is a view showing a correction method employed during motion vector correction processing according to a fourth embodiment of this invention.

FIG. 26 is a view showing a correction method employed during motion vector correction processing according to a fifth embodiment of this invention.

FIGS. 27A-27C are views showing a correction method employed during motion vector correction processing according to a sixth embodiment of this invention.

FIG. 28 is a flowchart showing the content of motion vector correction processing according to a seventh embodiment of this invention.

### DETAILED DESCRIPTION OF THE PREFERRED EMBODIMENTS

### First Embodiment

An image processing method and an image processing apparatus according to a first embodiment of this invention will now be described.

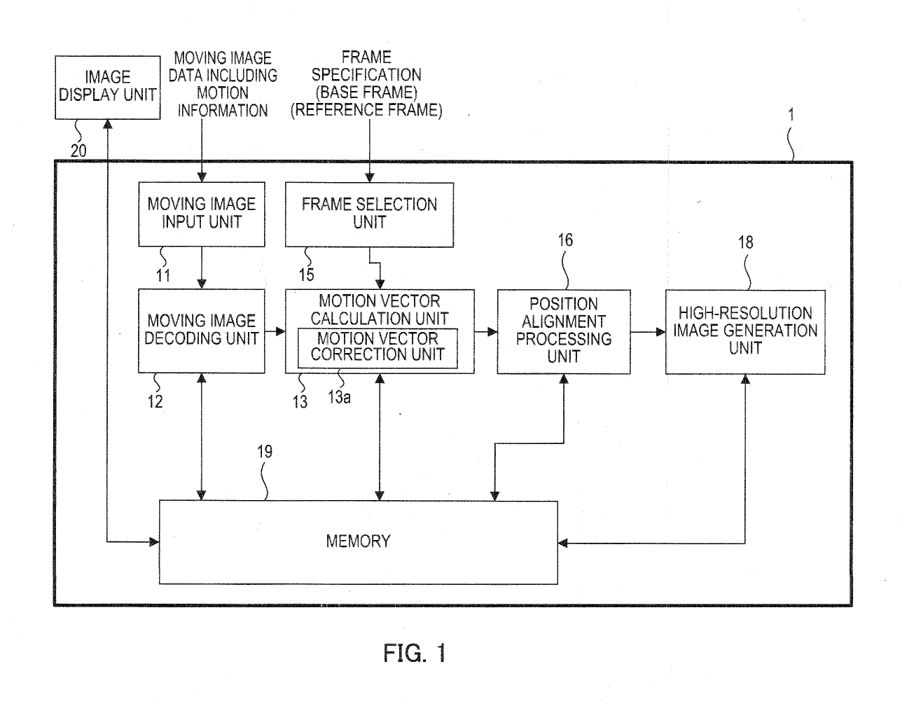

FIG. 1 is a block diagram showing the constitution of an image processing apparatus for implementing an image processing method according to a first embodiment of this invention. An image processing apparatus 1 shown in FIG. 1 includes a moving image input unit 11 into which moving image data including motion information are input, a moving image decoding unit 12, a motion vector calculation unit 13, a motion vector correction unit 13a, a frame selection unit 15 into which a frame specification is input from a user or the like, a position alignment processing unit 16, a high-resolution image generation unit 18, a memory 19, and an image display unit 20. The image display unit 20 may be provided integrally with or separately to the image processing apparatus 1.

In this embodiment, it is assumed that the moving image data including motion information are pre-existing data including any type of moving image data that include inter-frame image motion vector information. Examples of typical current moving image data including motion information are MPEG (Moving Picture Expert Group) 1, MPEG2, MPEG4, H.261, H.263, H.264, and so on.

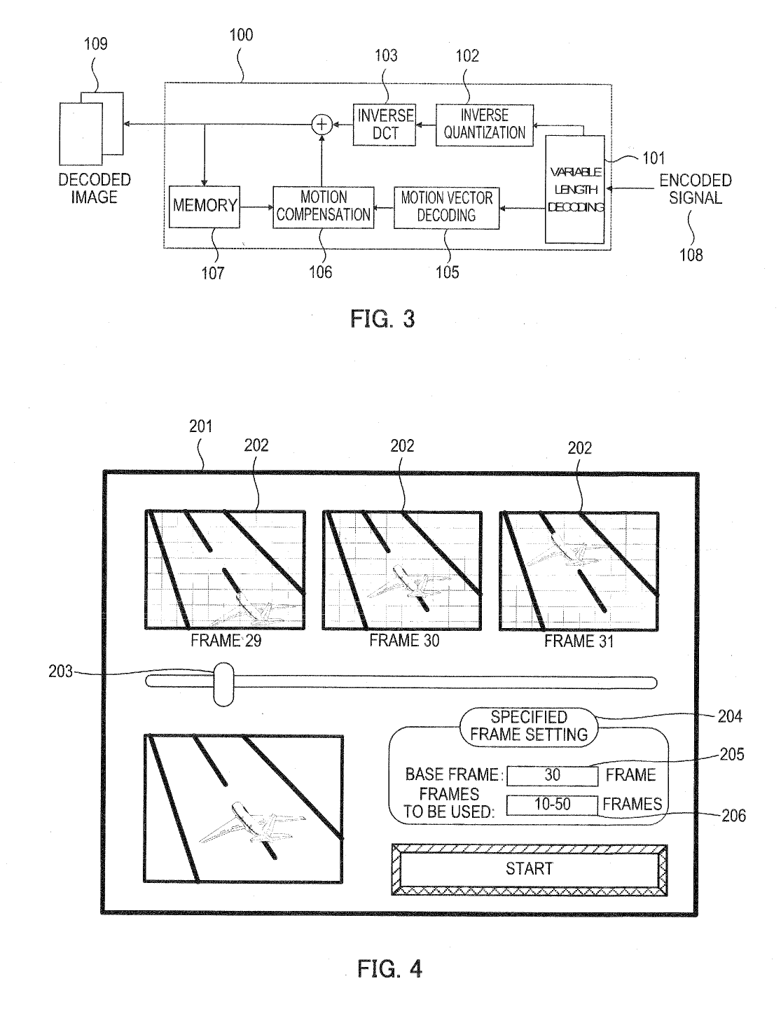

The moving image data including motion information are input into the moving image input unit 11, whereupon continuous frame images are decoded by the moving image decoding unit 12 and stored in the memory 19. In the case of MPEG, for example, the moving image decoding unit 12 decodes the frame images and extracts a motion vector by decoding and converting the inter-frame image motion vector information. In motion vector information recorded in MPEG, a difference value between a motion vector of a subject block and a motion vector of an adjacent block is compressed and encoded, and therefore conversion is performed by adding the difference value to the motion vector of the adjacent block after the motion vector information is decoded, whereupon the motion vector of the subject block is extracted. Further, the moving image decoding unit 12 corresponds to an MPEG4 decoder shown in FIG. 3, to be described below.

The stored decoded data can be displayed on the image display unit 20 as a moving image, and the user can view the image displayed by the image display unit 20 and specify a base frame to be subjected to resolution improvement, for example, and a reference frame to be used in the resolution improvement. In accordance with the frame specification from the user, the frame selection unit 15 outputs specified frame information to the motion vector calculation unit 13. The motion vector calculation unit 13 obtains the motion vector extracted by the moving image decoding unit 12 via the memory 19 or the moving image decoding unit 12, and calculates a motion vector value from each of the specified reference frames to the base frame using the obtained motion vector. The motion vector correction unit 13a is built into the motion vector calculation unit 13 and calculates an imaginary motion vector as required.

The calculated motion vector value is input into the position alignment processing unit 16 and used to perform position alignment between the base frame and the respective reference frames. The position alignment processing unit 16 is capable of accessing the decoded frame images stored in the memory 19 freely. Data relating to the aligned base frame and reference frames are input into the high-resolution image generation unit 18. The high-resolution image generation unit 18 uses the data relating to the aligned base frame and reference frames to generate a high-resolution image having a higher resolution than the frame image decoded by the moving image decoding unit 12, and stores the generated high-resolution image in the memory 19. The high-resolution image stored in the memory 19 may be displayed on the image display unit 20 so that the user can check the high-resolution image on the image display unit 20.

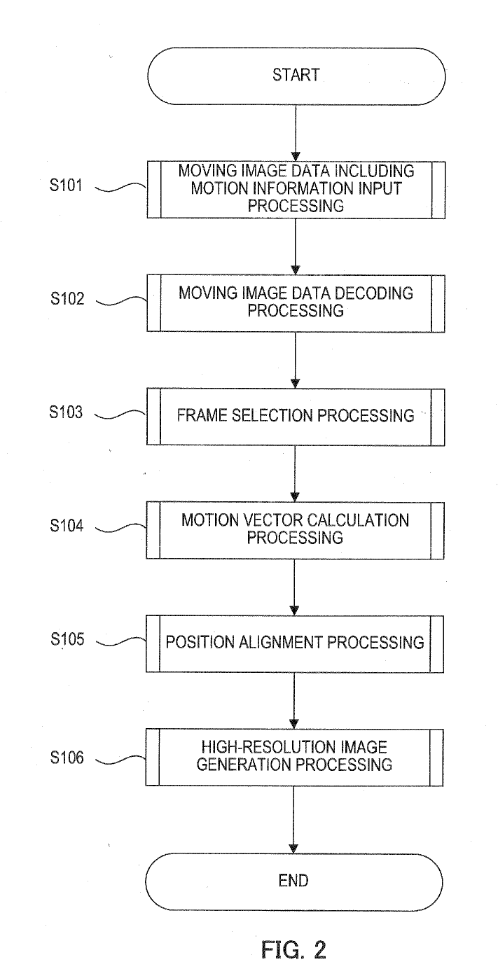

FIG. 2 is a flowchart showing processing performed in the image processing method according to this embodiment. In an image processing method that uses an inter-frame image motion vector recorded in moving image data according to this embodiment, first, moving image data are input through moving image data including motion information input processing (S101). Next, the input moving image data are decoded into motion vectors and continuous frame images through moving image data decoding processing (S102). Next, a base frame to be subjected to resolution improvement and a reference frame to be used in the resolution improvement are selected from the frame images on the basis of frame specification by the user through frame selection processing (S103). In motion vector calculation processing (S104), a motion vector value between the reference frame and the base frame is calculated by tracking each pixel of one or a plurality of frame images using the motion vector decoded in the moving image data decoding processing of S102. Positioning processing (S105) between the base frame and the reference frame is then performed, whereupon a high-resolution image is generated through high-resolution image generation processing (S106).

FIG. 3 is a block diagram showing the constitution of an MPEG4 decoding processing block. In this embodiment, the moving image decoding unit 12 shown in FIG. 1 corresponds to a decoder 100 in the MPEG4 decoding processing block shown in FIG. 3. Further, the moving image data including motion information correspond to an encoded signal 108 shown in FIG. 3. The encoded signal 108 input into the decoder 100 is decoded by a variable length decoding block 101, whereupon image data are output to an inverse quantization block 102 and motion information data are output to a motion vector decoding block 105. The image data are then subjected to inverse DCT (Discrete Cosine Transform) by an inverse DCT block 103. A motion vector decoded by the motion vector decoding block 105 is motion-compensated by a motion compensation block 106 relative to a subject block of a previous frame image stored in a memory 107, whereupon a decoded image 109 is generated by adding the motion-compensated motion vector to the image data subjected to inverse DCT.

FIG. 4 is a view showing a specification method employed by the user to specify the base frame and the reference frame during the frame specification according to this embodiment. As shown in FIG. 4, the user can specify the base frame and the reference frame by checking a display of a decoded image 202 on a display screen 201 used to specify the base frame and reference frame while moving a decoded image display frame switching knob 203, and setting a frame number of the base frame to be subjected to resolution improvement and a frame number of the reference frame to be used in the resolution improvement in a base frame setting tab 205 and a frames to be used setting tab 206, respectively, of a specified frame setting tab 204.

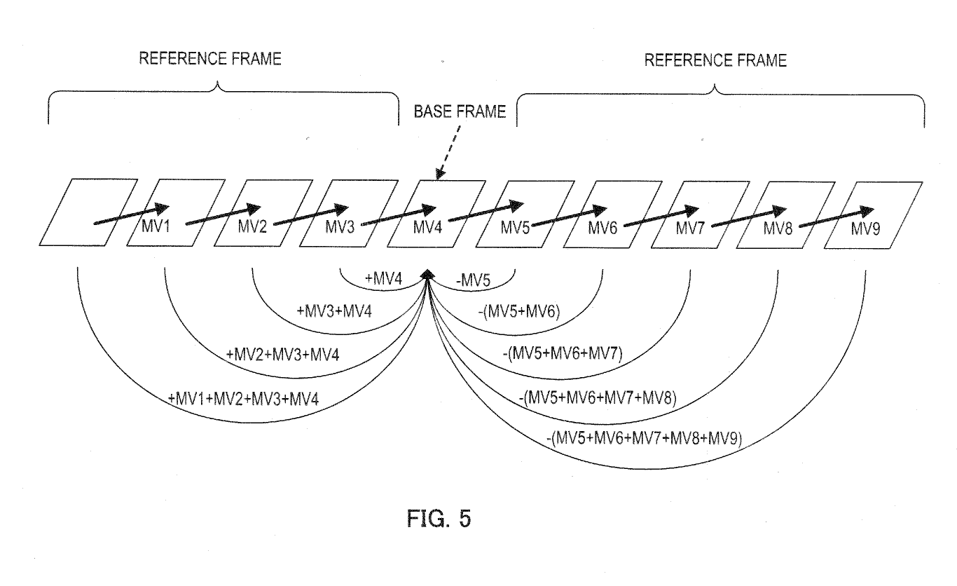

FIG. 5 is a view showing an outline of the motion vector calculation processing (S104) employed during the position alignment processing (S105) according to this embodiment. As shown in FIG. 5, a motion vector value from each reference frame to the base frame is determined on the basis of the frames specified by the user by accumulating motion vectors (MV1 to MV9 in FIG. 5) of the base frame and each employed reference frame selected in the frame selection processing (S103) while taking direction into account. By deforming the respective reference frames in accordance with the motion vector values, the base frame can be aligned with the respective reference frames. The motion vector calculation processing for determining the motion vector value is performed on each pixel of the frame image. Position alignment may be performed conversely in relation to the respective reference frames by deforming the base frame by a value obtained by inverting the directions of all of the motion vectors determined in the motion vector calculation processing. Hence, by tracking each pixel of one or a plurality of frame images using a motion vector included in each frame image, a motion vector value from one frame image to another frame image can be determined, and as a result, a plurality of frame images can be aligned.

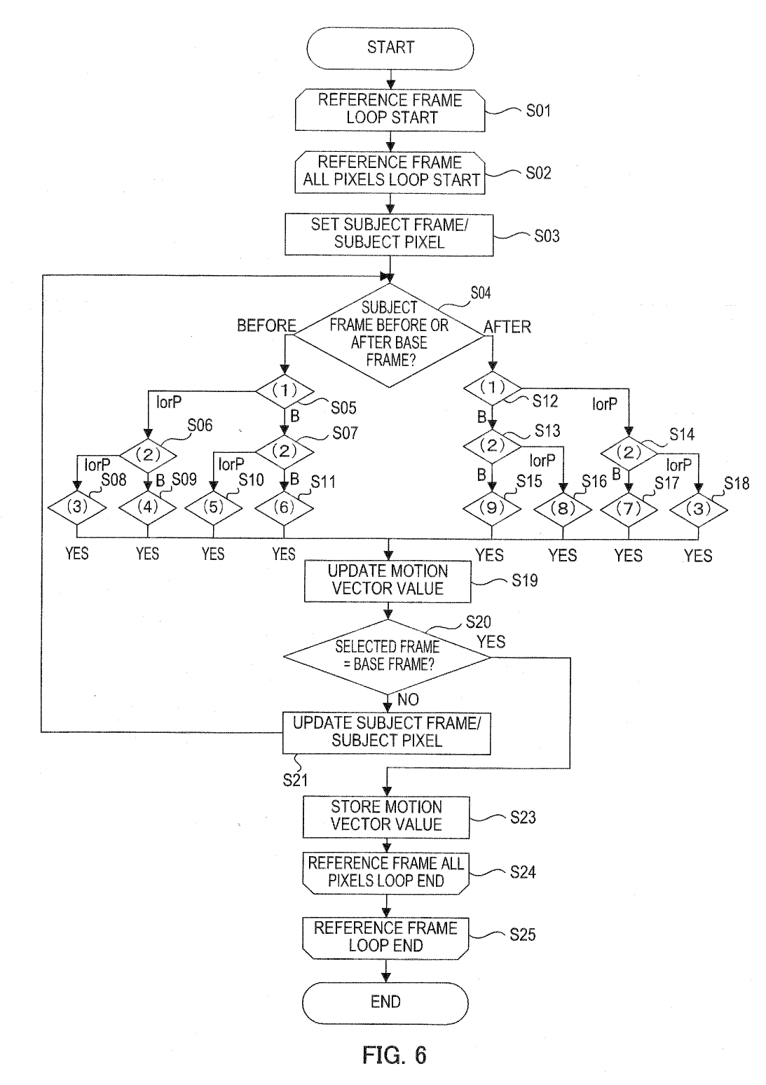

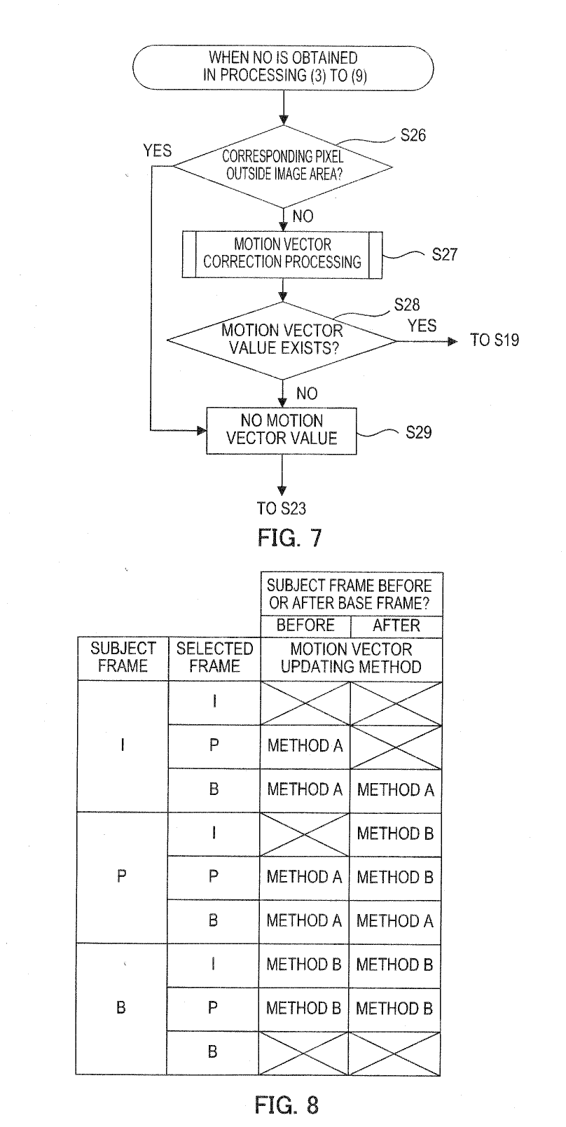

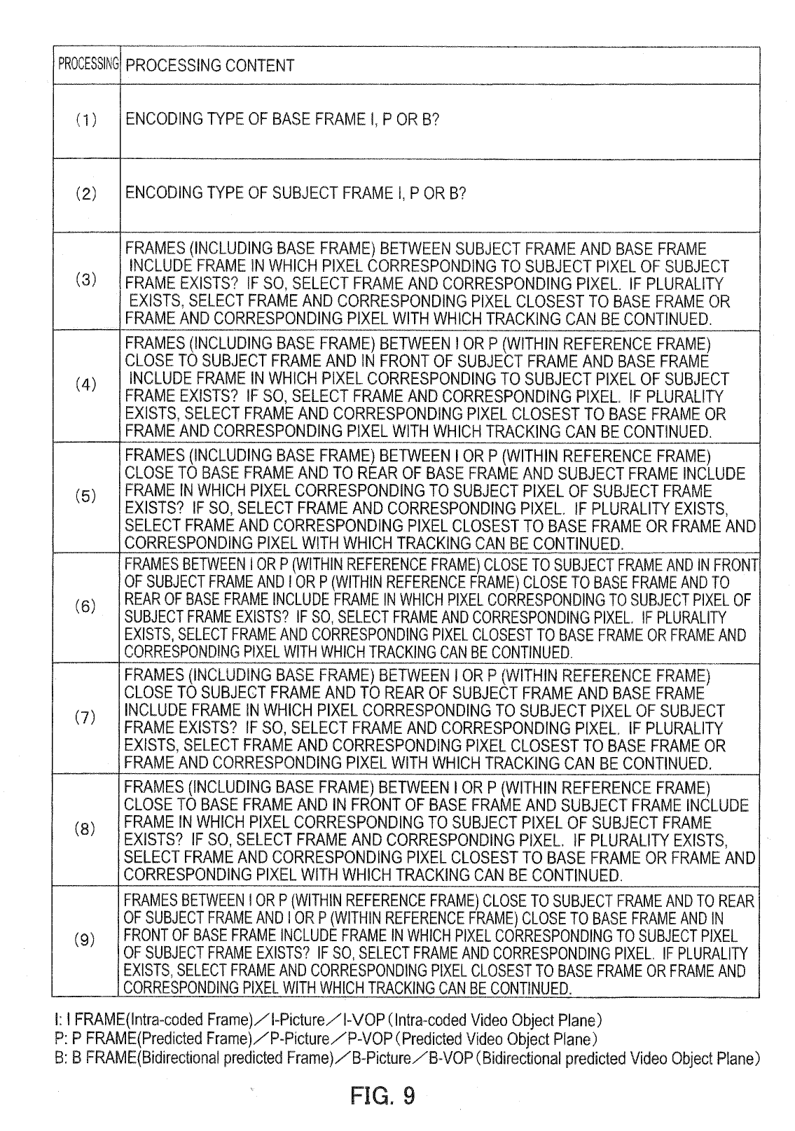

FIGS. 6 and 7 are flowcharts showing the content of the motion vector calculation processing (S104) of FIG. 2. The processing content of processing (1) to (9) in FIG. 6 is shown in FIG. 9. In the following description, I denotes “I frame (Intra-coded Frame)/I-Picture/I-VOP (Intra-coded Video Object Plane”, P denotes “P frame (Predicted Frame)/P-Picture/P-VOP (Predicted Video Object Plane”, and B denotes “B frame (Bidirectional predicted Frame)/B-Picture/B-VOP (Bidirectional predicted Video Object Plane”, while a frame image is referred to simply as a frame. The I frame (I-VOP), P frame (P-VOP) and B frame (B-VOP) will be described later. First, the motion vector calculation processing (S104) will be described.

To calculate the motion vector value in the motion vector calculation processing (S104), processing is performed using a loop (S01, S25) for the frames other than the base frame (i.e. the reference frames) and a loop (S02, S24) for all of the pixels in the respective reference frames, from among the base frame and reference frames selected in the frame selection processing (S103).

In the intra-loop processing, first, subject frame/subject pixel setting processing (S03) is performed to set a source subject frame and a subject frame as reference frames and to set a source subject pixel and a subject pixel as reference frame subject pixels. Here, the subject frame is a frame to which a pixel (including a pre-tracking initial pixel) tracked to a midway point using the motion vector, as described above, belongs at a set point in time, while the source subject frame is a frame to which the tracked pixel belonged previously. Further, the subject pixel is the pixel (including the pre-tracking initial pixel) tracked to a midway point at the set point in time, while the source subject pixel is a previously tracked pixel.

Following the subject frame/subject pixel setting processing (S03), a front/rear (before/after) relationship between the subject frame and the base frame is determined (S04), whereupon the encoding type of the base frame is determined in processing (1) (S05, S12) and the encoding type of the subject frame is determined in processing (2) (S06, S07, S13, S14).

Next, determination/selection processing is performed in processing (3) to (9) (S08, S09, S10, S11, S15, S16, S17, S18), taking into account combinations of encoding types. In the processing (3) to (9), as shown in FIG. 9, when a pixel corresponding to the subject pixel is searched for in order to track the subject frame to the base frame using the motion vector and a frame including a pixel that corresponds to the subject pixel is found within a predetermined range, the pixel is selected as a tracking destination pixel together with the frame including the pixel. When a pixel corresponding to the subject pixel is found in the processing (3) to (9) (YES), this means that a traceable motion vector exists.

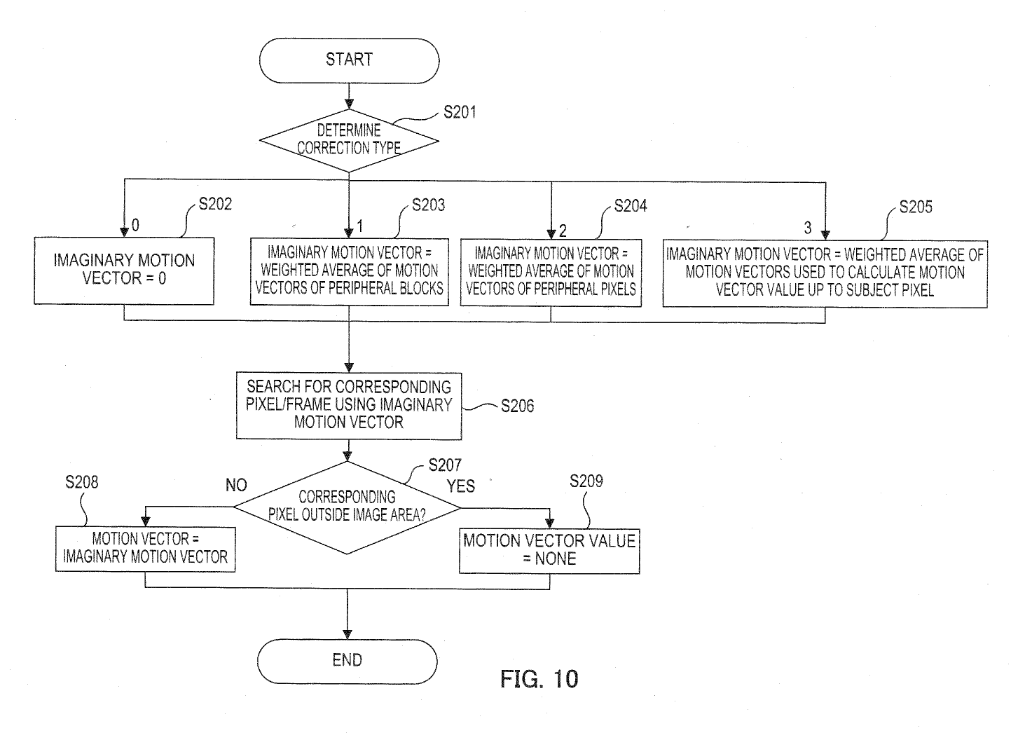

When a pixel corresponding to the subject pixel and a corresponding frame are not selected in the processing (3) to (9) (S08, S09, S10, S11, S15, S16, S17, S18) (NO), the routine advances to processing shown in FIG. 7, where the reason for “NO” is determined (S26). In S26, when a motion vector exists but the pixel corresponding to the subject pixel is outside of an image area, “no motion vector value” (S29) is stored (S23), whereupon the routine advances to the end of the reference frame all pixel loop (S24). When it is determined in S26 that the pixel corresponding to the subject pixel is within the image area but a motion vector does not exist, an imaginary motion vector is calculated in motion vector correction processing (S27, to be described below). When the pixel corresponding to the subject pixel is outside of the image area even with the imaginary motion vector, “no motion vector value” is set (see FIG. 10). After calculating the imaginary motion vector in the motion vector correction processing (S27), the presence of a motion vector value is determined (S28), and when no motion vector value exists, “no motion vector value” (S29) is stored (S23), whereupon the routine advances to the end of the reference frame all pixel loop (S24). When a motion vector value exists in S28, the motion vector value is updated using the imaginary motion vector (S19).

When a pixel corresponding to the subject pixel and a corresponding frame are selected in the processing (3) to (9) (S08, S09, S10, S11, S15, S16, S17, S18) (YES), the motion vector value is updated by accumulating the motion vector, taking direction into account, in the motion vector value updating processing (S19).

FIG. 8 is a view showing a method of updating the motion vector value during the motion vector value updating processing (S19). There are two methods of updating the motion vector value. In an updating method A shown in FIG. 8, a motion vector from the pixel of the selected frame corresponding to the subject pixel to the subject pixel of the subject frame is accumulated taking direction into account. In an updating method B shown in FIG. 8, a motion vector from the subject pixel of the subject frame to the pixel of the selected frame corresponding to the subject pixel is accumulated taking direction into account. As shown in FIG. 8, the updating method is selected in accordance with the subject frame, the encoding type of the selected frame, and a front/rear (before/after) relationship between the subject frame and the base frame.

Next, comparison processing (S20) is performed on the selected frame and the base frame. When a match is found, this means that a motion vector value from the subject pixel of the reference frame to the pixel of the base frame corresponding to the subject pixel has been determined, and therefore the motion vector value is stored (S23), whereupon the routine advances to the end of the reference frame all pixel loop (S24). When a match is not found, subject frame/subject pixel updating processing (S21) is performed to update the subject frame to the frame selected in the processing (3) to (9). As a result, the subject pixel is updated to the pixel selected in the processing (3) to (9), whereupon the routine returns to the processing (S04) for determining the front/rear relationship between the subject frame and the base frame. When the intra-loop processing has been performed for the reference frame all pixel loop (S02, S24) and the reference frame loop (S01, S25) of each reference frame, the motion vector calculation processing (S104) is terminated.

FIG. 10 is a flowchart showing the content of the motion vector correction processing (S27). In the motion vector correction processing (S27), first, motion vector correction types are determined (S201), whereupon a different imaginary motion vector is calculated for each correction type. The correction types may be set through user input, for example, or may be set in advance in accordance with maker parameters and the like.

In the example illustrated in this embodiment, when the correction type is 0, the imaginary motion vector is set at 0 (S202). When the correction type is 1, the imaginary motion vector is calculated by determining the weighted average of motion vectors included in peripheral blocks (to be described below) of the subject pixel (S203). When the correction type is 2, the imaginary motion vector is calculated by determining the weighted average of motion vectors included in peripheral pixels of the subject pixel (S204). When the correction type is 3, the imaginary motion vector is calculated by determining the weighted average of the motion vectors used to calculate the motion vector value from a pixel of the reference frame to the subject pixel (S205). Tracking is then performed using the imaginary motion vector calculated in S202 to S205, whereupon a pixel corresponding to a tracking destination subject pixel and a frame to which the pixel belongs are searched for (S206) and a determination is made as to whether or not the pixel corresponding to the subject pixel is outside of the image area (S207). When the pixel corresponding to the subject pixel is within the image area, the imaginary motion vector is set as the motion vector (S208), and when the pixel corresponding to the subject pixel is not within the image area, “no motion vector value” is set (S209).

The motion vector calculation processing (S104) will now be described in detail using several patterns as examples. First, MPEG4 frame encoding types and macroblock encoding types within the respective encoding types will be described as a prerequisite to the description.

As noted above, three types of MPEG4 frames exist, namely I-VOP, P-VOP, and B-VOP. I-VOP is known as intra encoding, and during I-VOP itself encoding, prediction from another frame is not required as encoding is concluded within the frame. P-VOP and B-VOP are known as inter encoding, and during P-VOP itself encoding, predictive encoding is performed from a preceding I-VOP or P-VOP. During B-VOP itself encoding, predictive encoding is performed from a bidirectional (front-rear direction) I-VOP or P-VOP.

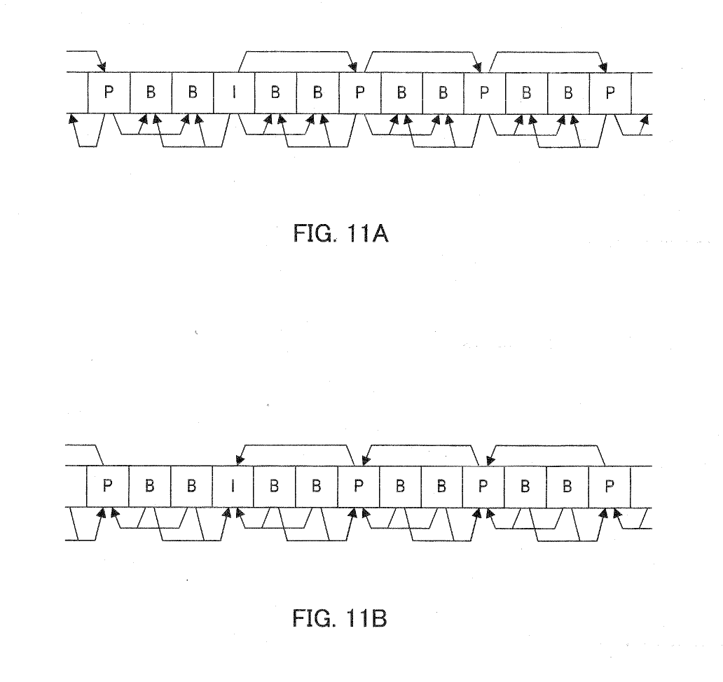

FIGS. 11A and 11B are views showing examples of a predicted direction during motion compensation and a direction of a motion vector (a frame toward which the motion vector is oriented) included in each frame (encoded and recorded in each frame) as a result of the motion compensation. FIG. 11A shows the predicted direction during motion compensation, while FIG. 11B shows the direction of the motion vector included in each frame in the example shown in FIG. 11A. Arrows in FIG. 11B are basically oriented oppositely to arrows in FIG. 11A.

For example, an I-VOP located fourth from the left in FIG. 11A is used to predict another frame but encoding of the I-VOP itself does not require prediction from another frame. In other words, as shown in FIG. 11B, a motion vector from the I-VOP located fourth from the left does not exist, and therefore the I-VOP itself does not possess a motion vector.

Further, a P-VOP located seventh from the left in FIG. 11A is predicted from the I-VOP located fourth from the left. In other words, as shown in FIG. 11B, a motion vector from the P-VOP located seventh from the left is oriented toward the I-VOP located fourth from the left, and therefore the P-VOP itself possesses a motion vector.

Further, a B-VOP located fifth from the left in FIG. 11A is predicted from the I-VOP located fourth from the left and the P-VOP located seventh from the left. In other words, as shown in FIG. 11B, motion vectors from the B-VOP located fifth from the left are oriented toward the I-VOP located fourth from the left and the P-VOP located seventh from the left, and therefore the B-VOP itself possesses motion vectors.

However, in encoding such as MPEG4, an entire frame is not encoded at once, and instead, encoding is performed by dividing the frame into a plurality of macroblocks. In this case, several modes are provided for encoding each macroblock, and therefore motion vectors oriented in the directions described above do not always exist.

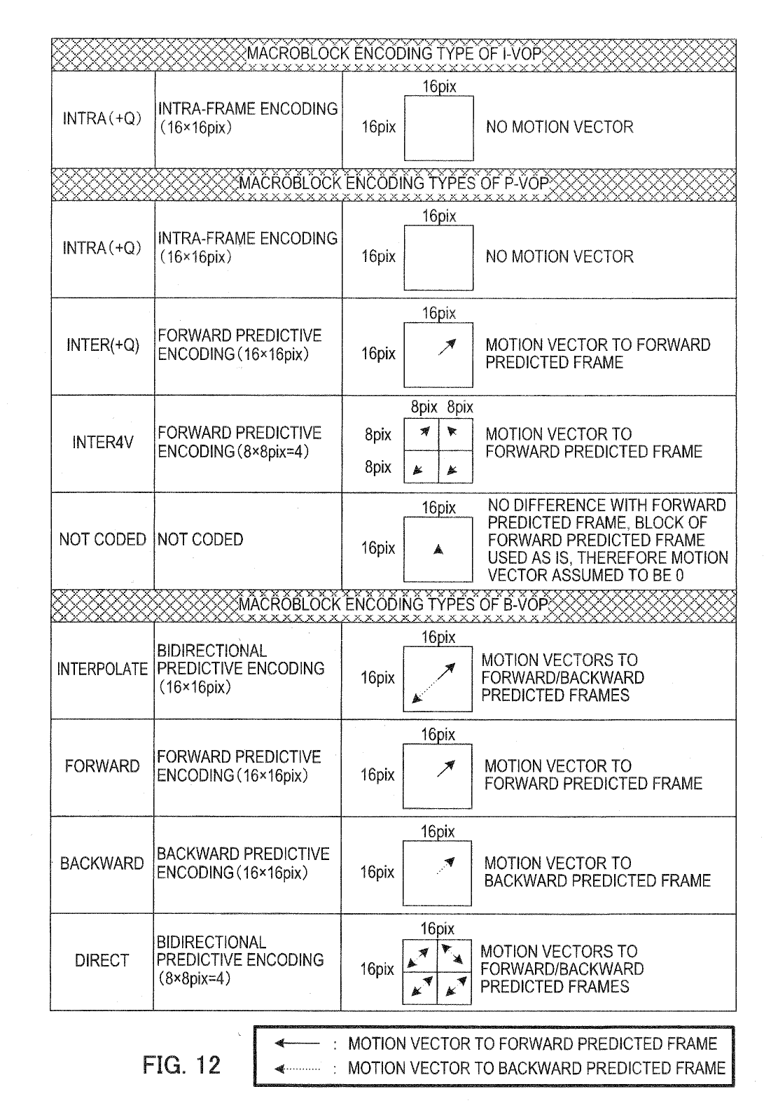

FIG. 12 is a view showing a macroblock encoding mode of each frame encoding type and a motion vector included in each macroblock in each mode. As shown in FIG. 12, an INTRA (+Q) mode is the only I-VOP macroblock encoding type. In this encoding type, 16×16 pixel intra-frame encoding is performed, and therefore no motion vectors exist.

The P-VOP macroblock encoding type includes four modes, namely INTRA (+Q), INTER (+Q), INTER4V, and NOT CODED. In INTER (+Q), 16×16 pixel intra-frame encoding is performed, and therefore no motion vectors exist. In INTER (+Q), 16×16 pixel forward predictive encoding is performed, and therefore a single motion vector oriented toward a forward predicted frame exists. In INTER4V, the 16×16 pixels are divided by four such that forward predictive encoding is performed in 8×8 pixel units, and therefore four motion vectors oriented toward the forward predicted frame exist. In NOT CODED, a difference with the forward predicted frame is small, and therefore the image data of a macroblock located in the same position as the forward predicted frame is used as is, without performing encoding. Hence, in actuality, no motion vectors exist. However, in this embodiment, it is assumed that a single motion vector oriented toward the forward predicted frame and having a value of “0” exists.

The B-VOP macroblock encoding type includes four modes, namely INTERPOLATE, FORWARD, BACKWARD, and DIRECT. In INTERPOLATE, 16×16 pixel bidirectional predictive encoding is performed, and therefore two motion vectors oriented respectively toward the forward predicted frame and a backward predicted frame exist. In FORWARD, 16×16 pixel forward predictive encoding is performed, and therefore a single motion vector oriented toward the forward predicted frame exists. In BACKWARD, 16×16 pixel backward predictive encoding is performed, and therefore a single motion vector oriented toward the backward predicted frame exists. In DIRECT, the 16×16 pixels are divided by four such that forward/backward predictive encoding is performed in 8×8 pixel units, and therefore four motion vectors oriented respectively toward the forward and backward predicted frames exist.

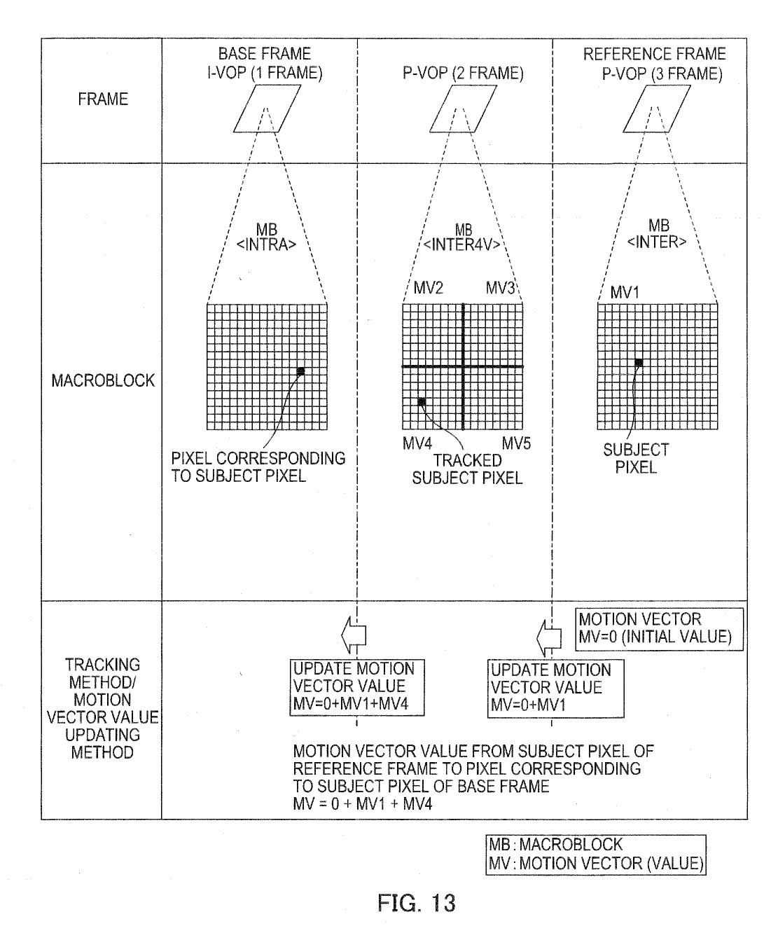

On the basis of this prerequisite, the motion vector calculation processing (S104) will now be described in detail using several patterns as examples, with reference to FIGS. 13 to 20B.

FIG. 13 is a view showing an example of tracking in the motion vector calculation processing (S104). In the example shown in FIG. 13, a first frame is an I-VOP, a second frame and a third frame are P-VOPs, the first frame serves as the base frame, and the third frame serves as the reference frame. A subject pixel in the third frame serving as the reference frame is a pixel indicated by diagonal lines, and first, the motion vector of the macroblock including the subject pixel is searched for. In this example, the macroblock encoding type is INTER and the motion vector of the macroblock is MV1, and therefore the position of the subject pixel is moved using MV1. The moved pixel position is thus aligned with a position within the second frame P-VOP, whereupon the motion vector of the macroblock including the subject pixel is searched for similarly in relation to the corresponding subject pixel position of the second frame. In this example, the macroblock encoding type is INTER4V and the macroblock possesses four motion vectors. However, the motion vector of the 8×8 pixel block including the subject pixel is MV4, and therefore the position of the tracked subject pixel is moved further using MV4. The moved pixel position is then aligned with a position within the first frame I-VOP. In this example, the first frame is the base frame, and therefore the pixel position of the reference frame can be tracked to the base frame. Hence, by accumulating an initial value 0, MV1, and MV4, which are used during the tracking, the motion vector value from the subject pixel of the reference frame to the pixel of the base frame corresponding to the subject pixel can be determined.

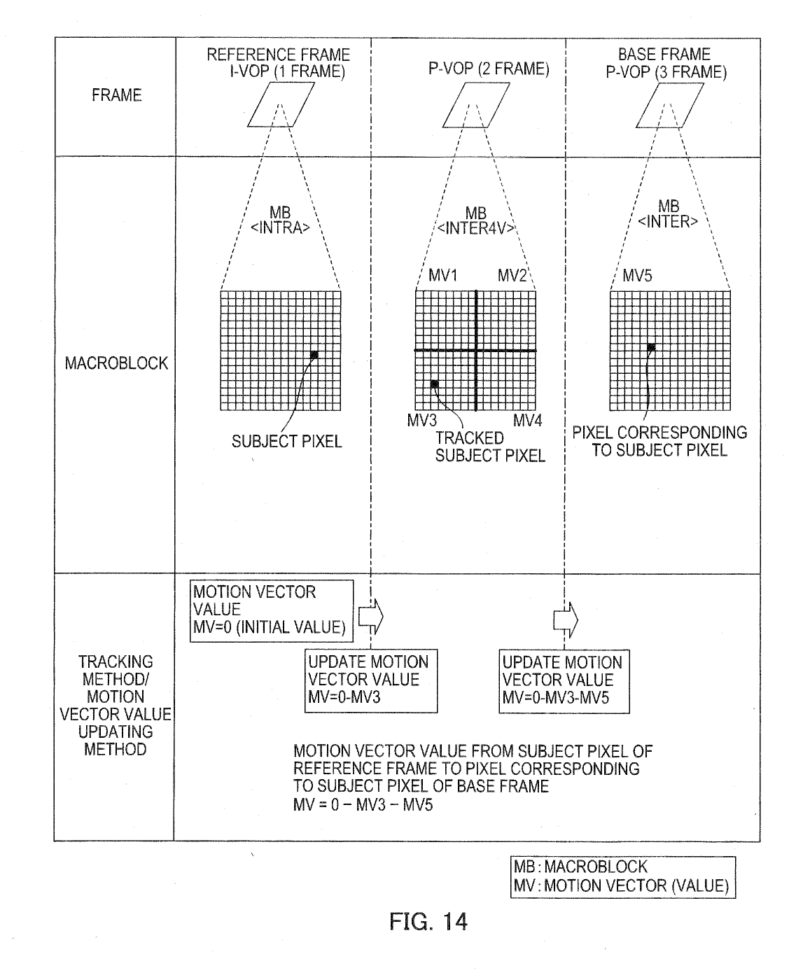

FIG. 14 is a view showing another example of tracking in the motion vector calculation processing (S104). In the example shown in FIG. 14, the first frame is an I-VOP, the second frame and third frame are P-VOPs, the third frame serves as the base frame, and the first frame serves as the reference frame. The subject pixel in the first frame serving as the reference frame is a pixel indicated by diagonal lines, and first, a pixel corresponding to the subject pixel of the first frame is searched for from all of the pixels of the second frame P-VOP, which has a motion vector oriented toward the first frame. When a corresponding pixel is found, the position of the subject pixel is moved using -MV3, which is obtained by inverting the direction of the motion vector (in this example, INTER4V, MV3) of the macroblock of the second frame including the pixel, such that the moved pixel position is aligned with a position within the second frame P-VOP, whereupon a pixel corresponding to the subject pixel of the second frame is searched for similarly from all of the pixels of the third frame P-VOP in relation to the position of the corresponding second frame subject pixel. When a corresponding pixel is found, the position of the subject pixel is moved using -MV5, which is obtained by inverting the direction of the motion vector (in this example, INTER, MV5) of the macroblock of the third frame including the pixel, such that the moved pixel position is aligned with a position within the third frame P-VOP. In this example, the third frame is the base frame, and therefore the pixel position of the reference frame can be tracked to the base frame. Hence, by accumulating the initial value 0, -MV3, and -MV5, which are used during the tracking, the motion vector value from the subject pixel of the reference frame to the pixel of the base frame corresponding to the subject pixel can be determined.

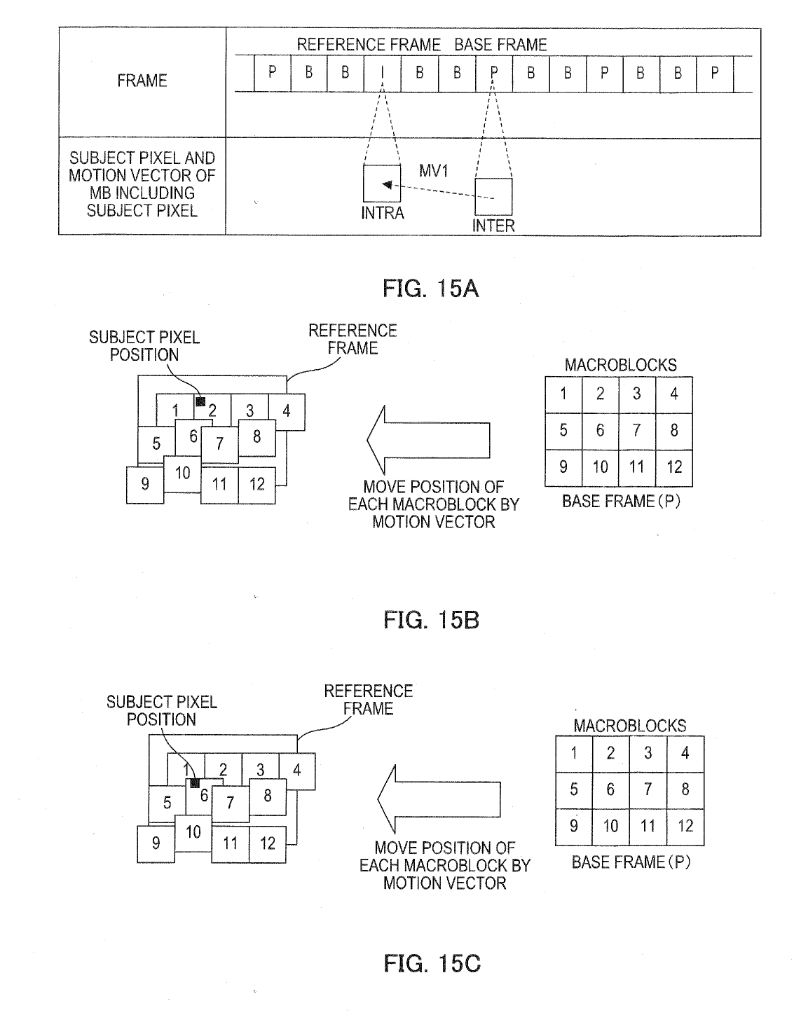

FIGS. 15A-15C are views showing a method of searching for a pixel and a motion vector corresponding to the subject pixel in the example of FIG. 14. FIGS. 15A-15C show a method of searching for a pixel corresponding to a subject pixel of the first frame from all pixels of the second frame P-VOP, which has a motion vector oriented toward the first frame, and a method of searching for a pixel corresponding to a subject pixel of the second frame from all pixels of the third frame P-VOP, in the example of FIG. 14. In the example shown in FIG. 15A, the pixel of a base frame (P-VOP) located seventh from the left to which a subject pixel of a reference frame (I-VOP) located fourth from the left corresponds and the motion vector (MV1 in FIG. 15A) of the macroblock including the pixel are searched for.

As shown in FIG. 15B, first, the positions of all macroblocks (all pixels) of the base frame (P) are moved using the motion vectors of the respective macroblocks (all pixels). The result of this movement is shown on the left of FIG. 15B. In an image region resulting from this position movement, the position of the subject pixel of the reference frame is marked, and the pixel located in this position after moving the base frame is the pixel corresponding to the subject pixel. In the example shown in FIG. 15B, a pixel in a macroblock 2 is the pixel corresponding to the subject pixel, and therefore the corresponding pixel in the original macroblock 2 and the motion vector of the macroblock 2 are selected. Thus, the pixel corresponding to the subject pixel can be found.

FIG. 15C shows a case in which a plurality of pixels exist in the marked position of the subject pixel following movement of the base frame. In this case, any of the plurality of pixels may be selected. In the example shown in FIG. 15C, the marked position of the subject pixel corresponds to pixels in macroblocks 1 and 6, and since the macroblock 1 is closer to the center, the corresponding pixel in the macroblock 1 may be selected. Alternatively, when processing is performed in a raster scan sequence for convenience such that a flag is overwritten, the macroblock 6, which comes later in the sequence, may be selected.

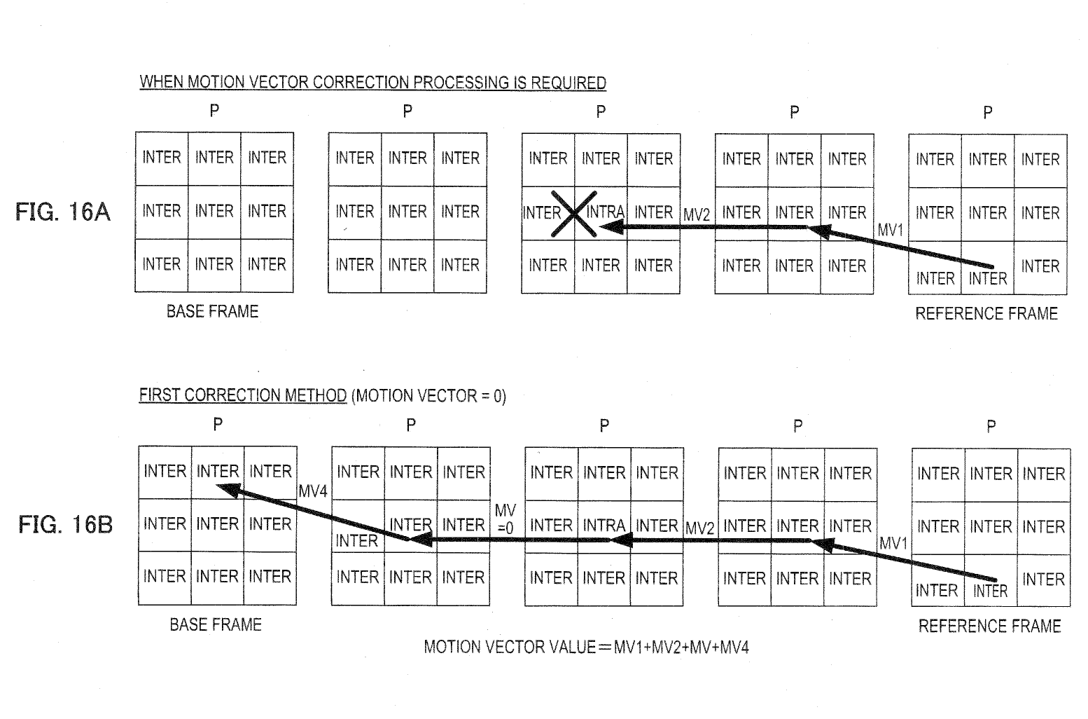

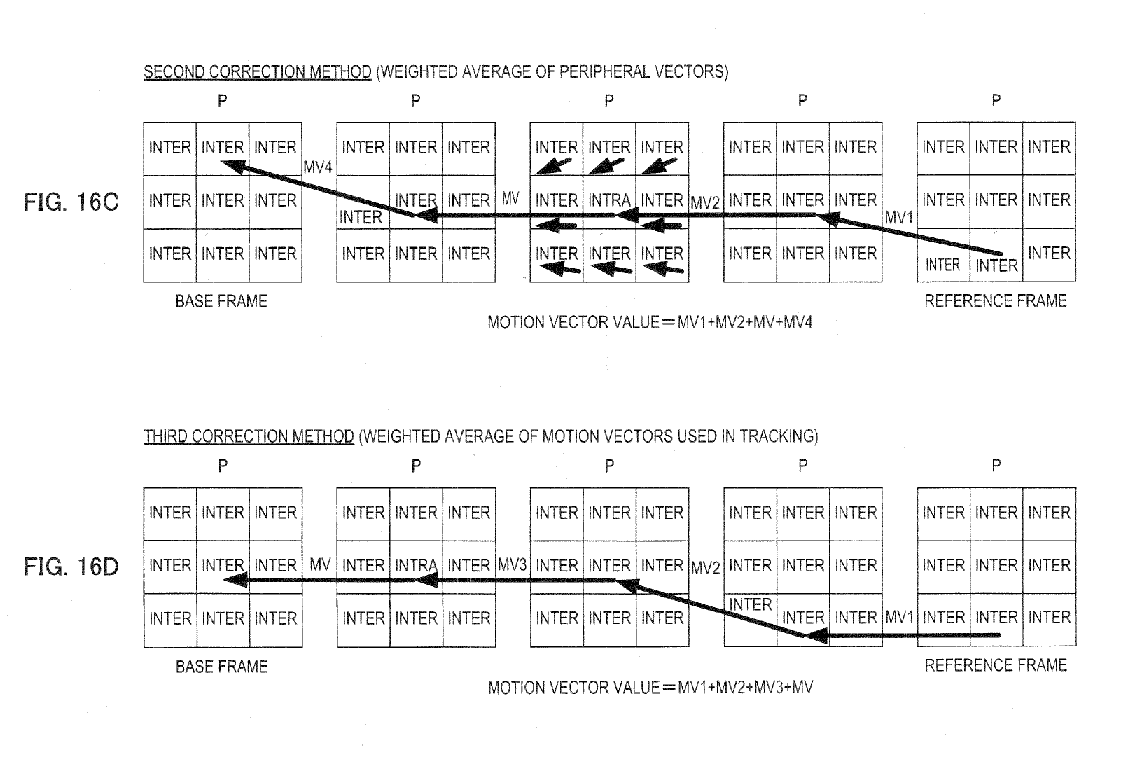

FIGS. 16A-16D are views showing a case in which motion vector correction processing (S27) is required in the motion vector calculation processing (104) and correction methods employed in the motion vector correction processing (S27). When motion vector correction processing shown in FIG. 16A is required, an INTRA block in which a motion vector is not included in the P frame exists during tracking of the subject pixel from the reference frame to the base frame using the motion vector of each pixel, and therefore tracking to the base frame is interrupted. In this case, the tracking can be continued by calculating an imaginary motion vector from a subject pixel of a P frame located third from the left to a P frame located second from the left using the motion vector correction processing (S27) according to this embodiment.

In a first correction method shown in FIG. 16B, the tracking is continued by setting the imaginary motion vector of the subject pixel in the P frame located third from the left at 0.

In a second correction method shown in FIG. 16C, the imaginary motion vector of the subject pixel in the P frame located third from the left is calculated by determining a weighted average of the motion vectors of blocks on the periphery of the block including the subject pixel, and thus the tracking is continued. A method of calculating the imaginary motion vector in this case is shown in Equation (1).

$$MV = {\sum }_{i = 1}^{n} α i \times MV i \qquad ( 1 )$$

In Equation (1), MV is the imaginary motion vector, i is an identification number of a peripheral block, n is a sum total of the peripheral blocks, of is a weighting coefficient, and MVi is the motion vector of the peripheral block. For example, when the motion vectors of the blocks on the periphery of the block including the subject pixel in the P frame located third from the left in FIG. 16C are set as MV5 to MV12, the imaginary motion vector is determined by determining the weighted average of MV5 to MV12.

In a third correction method shown in FIG. 16D, the imaginary motion vector of the subject pixel in a P frame located second from the left is calculated by determining a weighted average of motion vectors (MV1, MV2, MV3 in FIG. 16D) used to calculate the motion vector value from the source subject pixel of the reference frame to the subject pixel, and thus the tracking is continued. A method of calculating the imaginary motion vector in this case is shown in Equation (2).

$$MV = {\sum }_{n = 1}^{m} α n \times MV n \qquad ( 2 )$$

In Equation (2), MV is the imaginary motion vector, n is an identification number of a motion vector used to calculate the motion vector value from the source subject pixel of the reference frame to the subject pixel, m is a sum total of the motion vectors used to calculate the motion vector value from the source subject pixel of the reference frame to the subject pixel, αi is a weighting coefficient, and MVn is a motion vector used to calculate the motion vector value from the source subject pixel of the reference frame to the subject pixel. For example, in FIG. 16D, the motion vectors used to calculate the motion vector value from the source subject pixel of the reference frame to the subject pixel in the P frame located second from the left are MV1, MV2, MV3 in FIG. 16D, and therefore the imaginary motion vector is determined by determining the weighted average of MV1, MV2, MV3.

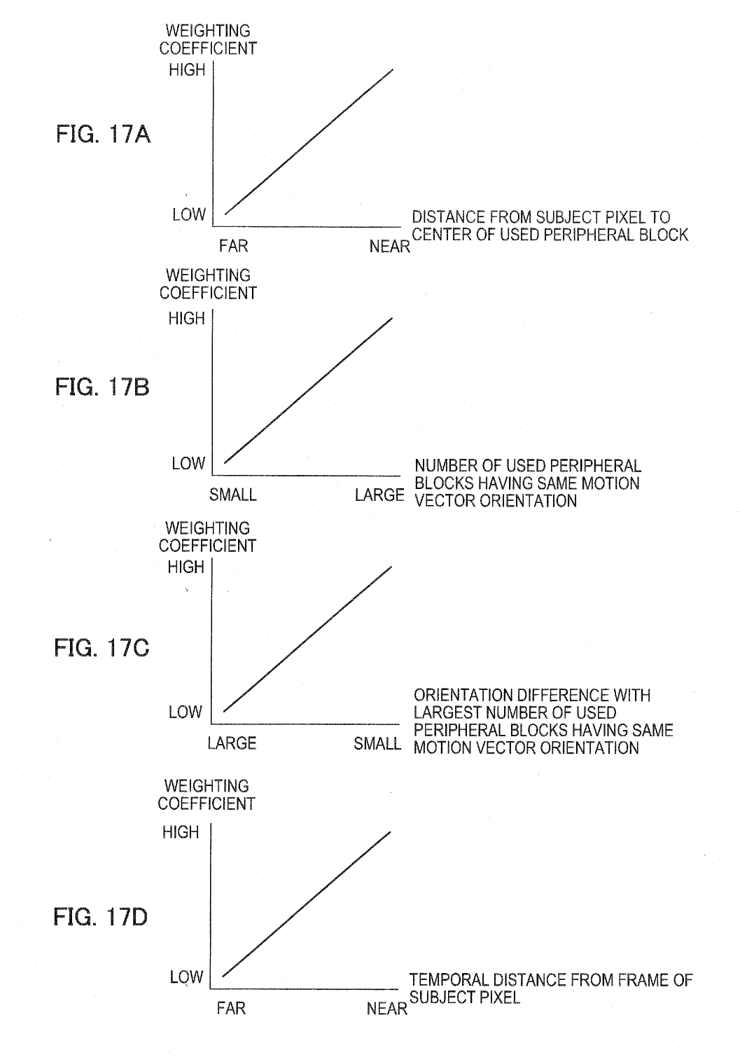

FIGS. 17A-17D are views showing examples of weighting coefficient settings in the motion vector correction processing (S27). FIG. 17A shows an example in which the weighting coefficient is determined in accordance with the subject pixel and a distance to the center of a peripheral block used to calculate the imaginary motion vector, which can be applied to the second correction method shown in FIG. 16C. In this case, it may be assumed that a correlation increases steadily as the distance decreases, and therefore a high weighting coefficient is applied. As the distance increases, on the other hand, a steadily lower weighting coefficient is applied.

FIG. 17B may be applied to the second correction method shown in FIG. 16C. Here, the motion vectors of the peripheral blocks used to calculate the imaginary motion vector are differentiated into nine directions (a direction differentiation method will be described below), for example, whereupon statistics are taken. Weighting is then performed in accordance with the statistics (a sum total) such that a high weighting coefficient is applied to a block having an identical direction to a direction having a large statistic and a low weighting coefficient is applied to a block having an identical direction to a direction having a small statistic.

FIG. 17C may be applied to the second correction method shown in FIG. 16C. Here, weighting is applied in accordance with a difference in orientation (a method of determining the difference in orientation will be described below) with the direction having the largest statistic obtained in the example shown in FIG. 17B such that a steadily higher weighting coefficient is applied as the difference in orientation decreases and a steadily lower weighting coefficient is applied as the difference in orientation increases.

FIG. 17D may be applied to the third correction method shown in FIG. 16D. Here, weighting is applied in accordance with a temporal distance between the frame including the subject pixel and the frame including the motion vector used to calculate the imaginary motion vector such that a steadily higher weighting coefficient is applied as the temporal distance decreases and a steadily lower weighting coefficient is applied as the temporal distance increases.

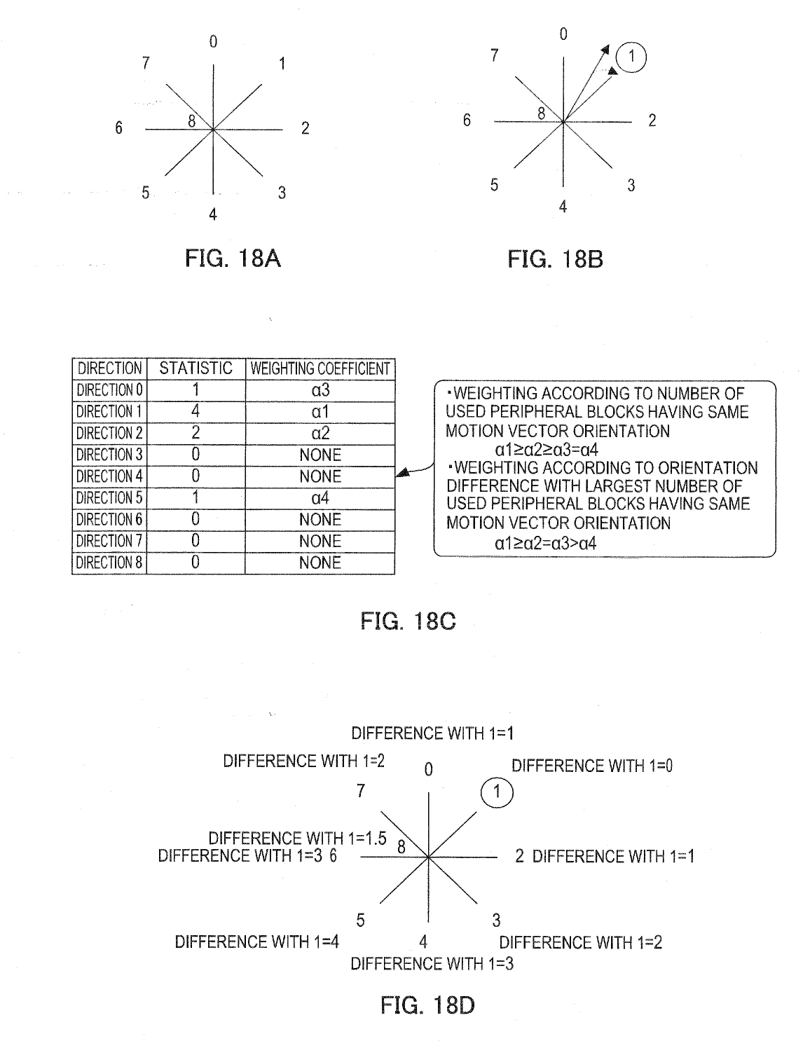

FIGS. 18A-18D are views showing direction differentiation and orientation differences during weighting coefficient setting in the motion vector correction processing (S27). FIG. 18A shows examples of classifications obtained when motion vectors are differentiated into nine directions, wherein a motion vector having a value of 0 corresponds to a direction 8. When the motion vector is between a direction 0 and a direction 1, as shown in FIG. 18B, the direction is differentiated in approximation of the closest direction.

FIG. 18C shows an example in which the weighting coefficient is set in accordance with direction and statistic. For example, the motion vectors of eight peripheral blocks are differentiated into nine directions, whereupon statistics are taken. According to the statistics, one block corresponds to direction 0, four blocks correspond to direction 1, two blocks correspond to direction 2, and one block corresponds to direction 5. When the weighting coefficients are set as α1 to α4, as shown in FIG. 18C, and weighting is performed in accordance with the number of motion vectors in the used peripheral blocks having the same orientation, as shown in FIG. 17B, the weighting coefficients are determined at a magnitude relationship of α1≧α2≧α3=α4.

When weighting is performed in accordance with the difference in orientation with the largest number of motion vectors in the used peripheral blocks having the same orientation, as shown in FIG. 17C, the weighting coefficients are determined at a magnitude relationship of aα1≧α2=α3>α4. The concept of orientation difference will now be described. As shown in FIG. 18D, when the orientation of the largest number of motion vectors of the peripheral blocks having the same orientation is direction 1, for example, direction 0 and direction 2 are closer to the orientation of direction 1 than the other directions, and therefore the difference is set at 1. Similarly, the difference of direction 7 and direction 3 is 2, the difference of direction 6 and direction 4 is 3, the difference of direction 5 is 4, and the difference of direction 8 is 1.5. The weighting coefficients can be determined on the basis of this concept. In this example, the number of motion vectors is not taken into account in relation to the motion vectors other than the largest number of motion vectors having the same orientation, but the weighting coefficient may be determined using a magnitude relationship of α1≧α2>α3>α4 by making the weighting coefficient of direction 2, which has a large statistic, greater than the weighting coefficient of direction 0, which has a small statistic, for example. Further, the four patterns of weighted motion vector correction processing shown in FIGS. 17A-17D may be used in combination, and the processing applied to the peripheral blocks may also be performed on peripheral pixels.

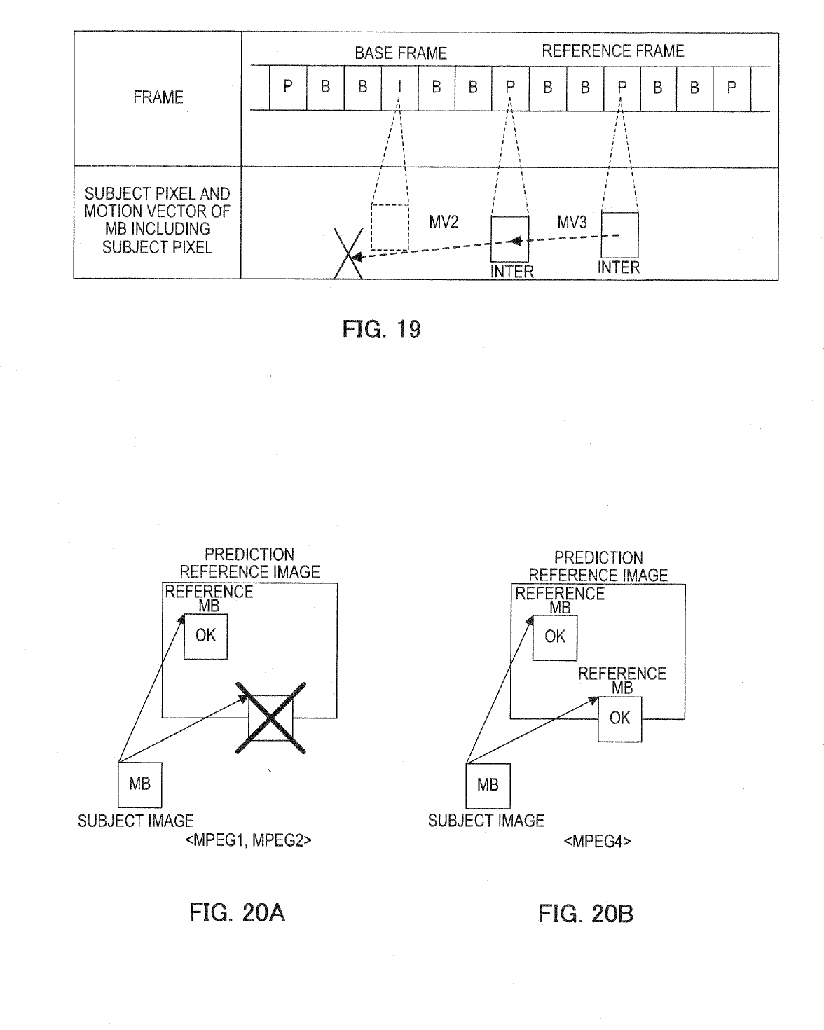

FIG. 19 is a view showing an example in which a pixel corresponding to a subject pixel deviates from an image area during tracking. In the example of FIG. 19, a subject pixel in a macroblock encoding type INTER of a reference frame located tenth from the left corresponds to a subject pixel in a macroblock encoding type INTER of a P-VOP located seventh from the left by a motion vector MV3 in the motion vector calculation processing (S104). Although motion vectors exist up to an I-VOP located fourth from the left, when an attempt is made to move the position of a seventh subject pixel from the left using a motion vector MV2, for example, the subject pixel deviates from the image area range and can no longer be tracked, and as a result, a motion vector value does not exist from the source subject pixel of the reference frame to the pixel of the base frame that corresponds to the subject pixel.

FIGS. 20A and 20B are views illustrating causes of a situation in which the pixel corresponding to the subject pixel deviates from the image area. FIGS. 20A and 20B show differences in methods of referencing a prediction reference image during predictive encoding in MPEG1, MPEG2 and MPEG4. In the case of MPEG1 and MPEG2, shown in FIG. 20A, the macroblock of the subject image must be held within the image area of the prediction reference image. In the case of MPEG4 shown in FIG. 20B, on the other hand, an unlimited motion vector method according to which not all reference macroblocks have to be held within the image area is introduced, and therefore a tracked pixel may deviate from the image area range.

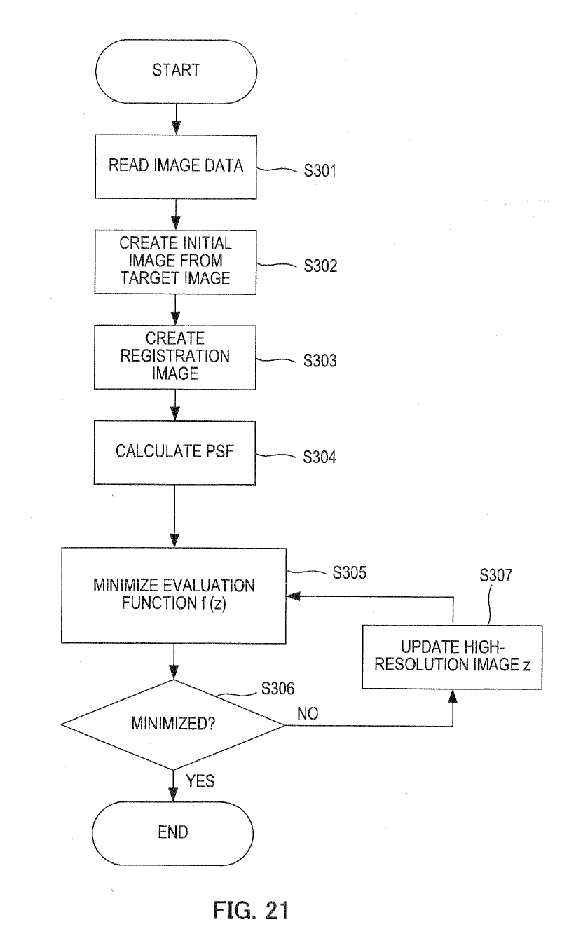

FIG. 21 is a flowchart showing an algorithm of the position alignment processing (S105) performed by the position alignment processing unit 16 and the resolution improvement processing (S106) performed by the resolution improvement processing unit 18. The position alignment processing (S105) and the resolution improvement processing (S106), which employs super-resolution processing, will now be described following the flow of the algorithm shown in FIG. 21.

First, image data of the base frame and image data of the reference frame are read (S301). A plurality of reference frames are preferably selected in the frame specification and frame selection processing (S103), and therefore the image data of the plurality of reference images are read in S301. Next, using the base frame as a resolution improvement processing target image, interpolation processing such as bilinear interpolation or bicubic interpolation is performed on the target image to create an initial image z₀ (S302). The interpolation processing may be omitted in certain cases.

Next, an image correspondence relationship between the target image and the reference frame is clarified using the motion vector value calculated in the motion vector calculation processing (S104) as an image displacement amount, whereupon overlapping processing is performed in a coordinate space having expanded coordinates of the target image as a reference to generate a registration image y (S303). Here, y is a vector representing image data of the registration image. The registration image y is generated by the position alignment processing (S105) of the position alignment processing unit 16. A method of generating the registration image y is disclosed in detail in “Tanaka, Okutomi: Speed-increasing algorithm of Reconfigurative Super-resolution Processing, Computer Vision and Image Media (CVIM) Vol. 2004, No. 113, pp. 97-104 (2004-11)”. The overlapping processing of S303 is performed by making pixel position associations between respective pixel values of a plurality of reference frames and the expanded coordinates of the target image, for example, and placing the respective pixel values on closest lattice points of the expanded coordinates of the target image. A plurality of pixel values may be placed on the same lattice point, but in this case, averaging processing is implemented on these pixel values. In this embodiment, the motion vector value calculated in the motion vector calculation processing (S104) is used as the image displacement amount between the target image (base frame) and reference frame.

Next, a PSF (Point Spread Function) taking into consideration image pickup characteristics such as an OTF (Optical Transfer Function) and a CCD aperture is determined (S304). The PSF is reflected in a matrix A shown below in Equation (3), and for ease, a Gauss function, for example, may be used. An evaluation function f (z) shown below in Equation (3) is then minimized using the registration image y generated in S303 and the PSF determined in S304 (S305), whereupon a determination is made as to whether or not f (z) is minimized (S306).

ƒ(z)=∥y−Az∥²+λg(z) (3)

In Equation (3), y is a column vector representing the image data of the registration image generated in S303, z is a column vector representing image data of a high-resolution image obtained by improving the resolution of the target image, and A is an image conversion matrix representing characteristics of the image pickup system such as a point image spread function of the optical system, blur caused by a sampling opening, and respective color components generated by a color mosaic filter (CFA). Further, g (z) is a regularization term taking into account image smoothness, a color correlation of the image, and so on, while λ is a weighting coefficient. A method of steepest descent, for example, may be used to minimize the evaluation function f (z) expressed by Equation (3). When a method of steepest descent is used, values obtained by partially differentiating f (z) by each element of z are calculated, and a vector having these values as elements is generated. As shown below in Equation (4), the vector having the partially differentiated values as elements is then added to z, whereby a high-resolution image z is updated (S307) and z at which f (z) is minimized is determined.

$${z}_{n + 1} = {z}_{n} + α \frac{\partial f ( z )}{\partial z} \qquad ( 4 )$$

In Equation (4), zₙ is a column vector representing the image data of a high-resolution image updated n times, and α is a stride of an update amount. The first time the processing of S305 is performed, the initial image z₀ determined in S302 may be used as the high-resolution image z. When it is determined in S306 that f (z) has been minimized, the processing is terminated and zₙ at that time is recorded in the memory 19 or the like as a final high-resolution image. Thus, a high-resolution image having a higher resolution than frame images such as the base frame and the reference frame can be obtained.

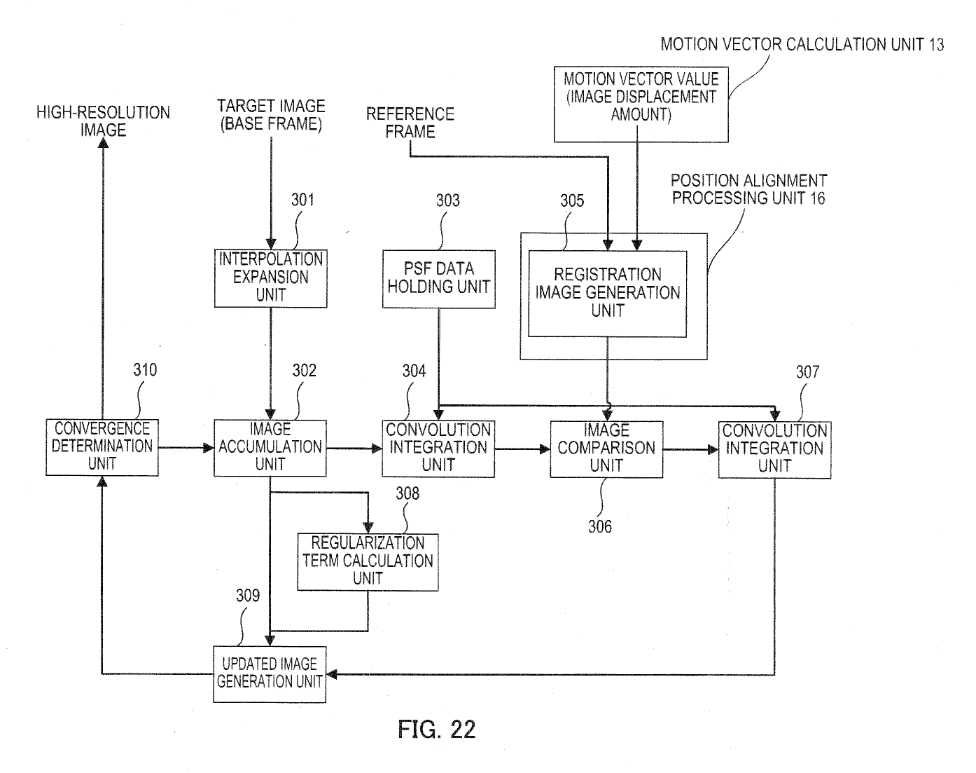

FIG. 22 is a block diagram showing a constitutional example of the high-resolution image generation unit 18. The motion vector calculation unit 13 and the position alignment processing unit 16 are also shown in FIG. 22. Here, the position alignment processing (S105) and the high-resolution image generation processing (S106) employing super-resolution processing performed by the high-resolution image generation unit 18 and so on will be described further. As shown in FIG. 22, the high-resolution image generation unit 18 includes an interpolation expansion unit 301, an image accumulation unit 302, a PSF data holding unit 303, a convolution integration unit 304, an image comparison unit 306, a convolution integration unit 307, a regularization term calculation unit 308, an updated image generation unit 309, and a convergence determination unit 310. Further, the position alignment processing unit 16 includes a registration image generation unit 305.

First, the base frame selected from the plurality of frames stored in the memory 19 in the frame selection processing (S103) is provided to the interpolation expansion unit 301 as the target image of the high-resolution image generation processing, whereupon interpolation expansion is performed on the target image (corresponding to S302 in FIG. 21). Examples of interpolation expansion methods that may be used here include bilinear interpolation and bicubic interpolation. The target image subjected to interpolation expansion by the interpolation expansion unit 301 is transmitted to the image accumulation unit 302 as the initial image z₀, for example, and accumulated therein. Next, the interpolation-expanded target image is provided to the convolution integration unit 304, where convolution integration with PSF data (corresponding to the image conversion matrix A of Equation (3)) provided by the PSF data holding unit 303 is performed.

Further, the reference frame stored in the memory 19 is provided to the registration image generation unit 305, whereupon the registration image y is generated using the motion vector value calculated by the motion vector calculation unit 13 as an image displacement amount by performing overlapping processing in a coordinate space having the expanded coordinates of the target image as a reference (corresponding to S303 in FIG. 21). The overlapping processing of the registration image generation unit 305 is performed by making pixel position associations between respective pixel values of a plurality of reference frames and the expanded coordinates of the target image, for example, and placing the respective pixel values on closest lattice points of the expanded coordinates of the target image. A plurality of pixel values may be placed on the same lattice point, but in this case, averaging processing is implemented on these pixel values.

Image data (a vector) convolution-integrated by the convolution integration unit 304 are transmitted to the image comparison unit 306, where difference image data (corresponding to (y−Az) in Equation (3)) are generated by calculating a difference in pixel values in a single pixel position with the registration image y generated by the registration image generation unit 305. The difference image data generated in the image comparison unit 306 are provided to the convolution integration unit 307, where convolution integration is performed with the PSF data provided by the PSF data holding unit 303. The convolution integration unit 307 convolution-integrates a transposed matrix of the image conversion matrix A of Equation (3), for example, with a column vector representing the difference image data to generate a vector in which |y−Az|² of Equation (3) is partially differentiated by each element of z.

Further, the image accumulated in the image accumulation unit 302 is provided to the regularization term calculation unit 308 where the regularization term g (z) of Equation (3) is determined and a vector in which the regularization term g (z) is partially differentiated by each element of z is determined. For example, the regularization teen calculation unit 308 performs color conversion processing from RGB to YCᵣC_{b} on the image data accumulated in the image accumulation unit 302, and determines a vector in which a high frequency-pass filter (Laplacian filter) is convolution-integrated in relation to the YCᵣC_{b} components (a luminance component and a chrominance component). A square norm (a square of the length) of the vector is then used as the regularization term g (z) to generate the vector in which g (z) is partially differentiated by each element of z. When a Laplacian filter is applied to the Cᵣ and C_{b} components (chrominance components), a false color component is extracted, but this false color component can be removed by minimizing the regularization term g (z). Therefore, by including the regularization term g (z) in Equation (3), prior information relating to an image to which the term “Typically, a chrominance component of an image varies smoothly” applies can be used, and as a result, a high-resolution image suppressing chrominance can be determined with stability.

The image data (vector) generated by the convolution integration unit 307, the image data (vector) accumulated in the image accumulation unit 302, and the image data (vector) generated by the regularization term calculation unit 308 are provided to the updated image generation unit 309. In the updated image generation unit 309, these image data (vectors) are added together after being multiplied by the weighting coefficients such as λ and α in Equations (3) and (4), and as a result, an updated high-resolution image is generated (corresponding to Equation (4)).

The high-resolution image updated by the updated image generation unit 309 is provided to the convergence determination unit 310, where a convergence determination is performed. In the convergence determination, the high-resolution image updating operation may be determined to have converged when a repetitive number of calculation relating to the convergence is larger than a fixed number. Alternatively, the high-resolution image updating operation may be determined to have converged when a difference between a recorded high-resolution image updated in the past and the current high-resolution image indicates an update amount which is smaller than a fixed value.

When the updating operation is determined to have converged by the convergence determination unit 310, the updated high-resolution image is stored in the memory 19 or the like as a final high-resolution image. When it is determined that the updating operation has not converged, the updated high-resolution image is provided to the image accumulation unit 302 for use in the next updating operation. This high-resolution image is then provided to the convolution integration unit 304 and the regularization term calculation unit 308 for use in the next updating operation. By repeating the processing described above such that the high-resolution image is gradually updated by the updated image generation unit 309, a favorable high-resolution image can be obtained. In this embodiment, the high-resolution image is generated during high-resolution image generation processing (S106), but instead of the high-resolution image generation processing (S106), smoothing processing, for example, may be performed in accordance with a weighted average such that the image quality of the frame image is improved by reducing random noise.

In this embodiment, even when a motion vector does not exist during tracking of a corresponding pixel, a motion vector value from one frame image to another frame image can be determined with minimal error by calculating an imaginary motion vector, and therefore frame image position alignment, high-resolution image generation, and so on can be performed with a high degree of precision.

### Second Embodiment

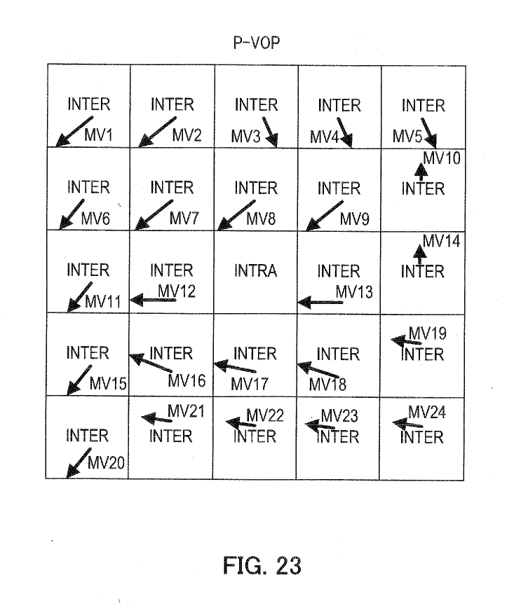

FIG. 23 is a view showing a correction method employed during motion vector correction processing according to a second embodiment of this invention. Apart from the points to be described below, the constitution of the image processing apparatus and the content of the image processing method according to this embodiment are identical to those of the image processing apparatus and image processing method according to the first embodiment, and therefore only the differences will be described.

In this embodiment, similarly to FIG. 16C of the first embodiment, the imaginary motion vector is calculated by determining the weighted average of the motion vectors of blocks on the periphery of the block including the subject pixel. However, a larger number of peripheral blocks than the first embodiment are used. In the example shown in FIG. 23, an imaginary motion vector of a central INTRA block is calculated by determining the weighted average of motion vectors MV1 to MV24 of peripheral blocks (see Equation (1)).

In this embodiment, the imaginary motion vector is calculated using a large number of motion vectors of peripheral blocks, and therefore an even more precise imaginary motion vector can be determined. All other effects are identical to those of the image processing method and image processing apparatus according to the first embodiment.

### Third Embodiment

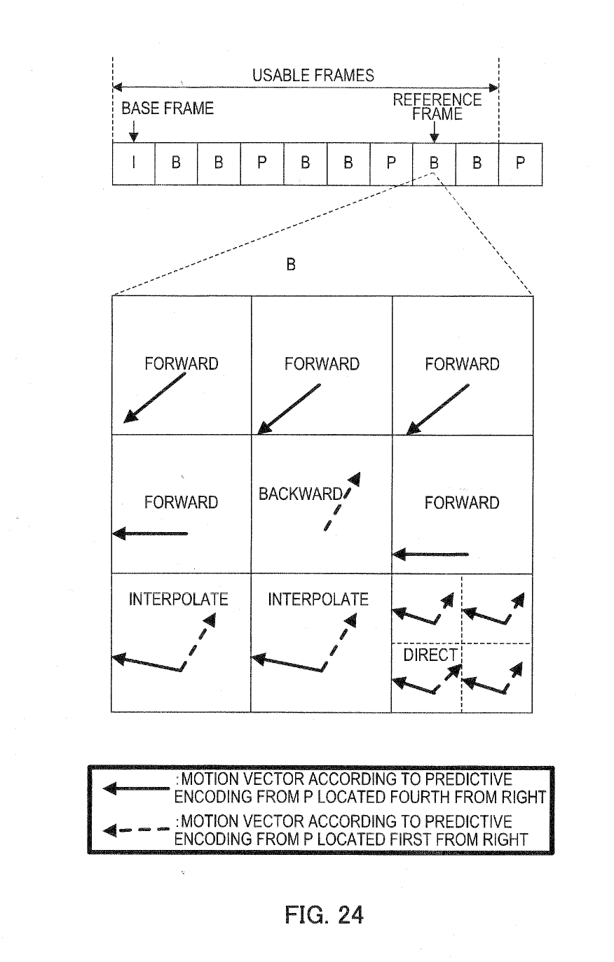

FIG. 24 is a view showing a correction method employed during motion vector correction processing according to a third embodiment of this invention. Apart from the points to be described below, the constitution of the image processing apparatus and the content of the image processing method according to this embodiment are identical to those of the image processing apparatus and image processing method according to the first embodiment, and therefore only the differences will be described.

FIG. 24 shows a case in which, due to the frame selection processing (S103) and the frame structure, pixel tracking cannot be performed. In the example of FIG. 24, during tracking to the base frame using a B frame located third from the right as a reference frame, the block that includes the subject pixel is BACKWARD-encoded and therefore possesses a motion vector, but the motion vector is oriented toward a P frame located first from the right. In this case, tracking may be performed to the P frame located first from the right initially and then to a P frame located fourth from the right, but in the example shown in FIG. 24, the P frame located first from the right has not been selected as a frame (reference frame) that can be used during frame specification and frame selection processing, and therefore the P frame located first from the right cannot be used.

The peripheral blocks of the block including the subject pixel of the B frame located third from the right include blocks encoded by FORWARD, INTERPOLATE, DIRECT, and so on, and the motion vectors of these blocks are oriented toward the P frame located fourth from the right. By processing these motion vectors using the second correction method shown in FIG. 16C, an imaginary motion vector of the central BACKWARD-encoded block can be determined.

In this embodiment, an imaginary motion vector is calculated using the motion vectors of the peripheral blocks even when pixel tracking cannot be performed due to frame structure or the like, and therefore a motion vector value from a reference frame to a base frame can be determined with minimal error. All other effects are identical to those of the image processing method and image processing apparatus according to the first embodiment.

### Fourth Embodiment

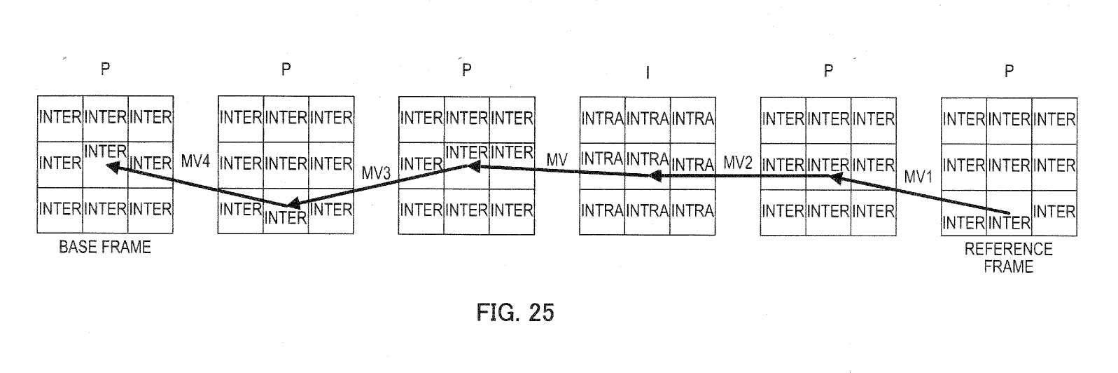

FIG. 25 is a view showing a correction method employed during motion vector correction processing according to a fourth embodiment of this invention. Apart from the points to be described below, the constitution of the image processing apparatus and the content of the image processing method according to this embodiment are identical to those of the image processing apparatus and image processing method according to the first embodiment, and therefore only the differences will be described.

In the example shown in FIG. 25, tracking is performed from a reference frame located first from the right to the base frame. However, an INTRA block exists in an I frame located third from the right, and therefore no motion vector exists, making it impossible to continue tracking. Therefore, first an imaginary motion vector MV is calculated using any one of the first to third correction methods shown in FIGS. 16B-16D, whereupon the tracking is continued using this MV. For example, when the third correction method of FIG. 16D is used, the imaginary motion vector MV is determined by determining the weighted average of MV1 and MV2 in FIG. 25.

After performing tracking to the next frame using MV and then continuing the tracking for one or more frames (two frames in the example of FIG. 25), the imaginary motion vector MV is updated using the motion vectors of the tracked one or more frames (MV3, MV4 in FIG. 25). In this embodiment, for example, the imaginary motion vector MV of the INTRA block is updated one or more times by determining the weighted average of MV1, MV2, MV3 and MV4 used during the tracking, and tracking is repeated upon every update. In this case, the imaginary motion vector may be updated an arbitrary number of times or until the imaginary motion vector MV converges.

In this embodiment, the imaginary motion vector is calculated using any one of the first to third correction methods, the tracking is continued using the imaginary motion vector, and when the tracking has continued for one or more frames, the imaginary motion vector is updated using the motion vectors of the one or more tracked frames. As a result, the imaginary motion vector can be determined with an even higher degree of precision. All other effects are identical to those of the image processing method and image processing apparatus according to the first embodiment.

### Fifth Embodiment

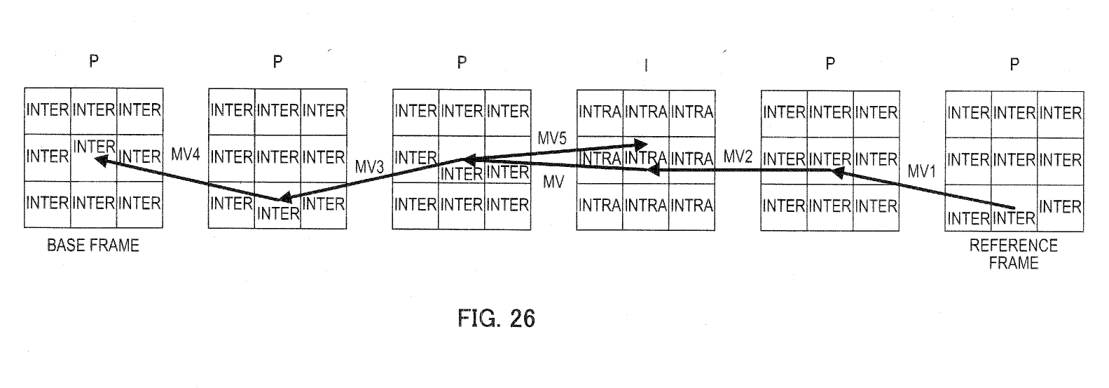

FIG. 26 is a view showing a correction method employed during motion vector correction processing according to a fifth embodiment of this invention. Apart from the points to be described below, the constitution of the image processing apparatus and the content of the image processing method according to this embodiment are identical to those of the image processing apparatus and image processing method according to the first embodiment, and therefore only the differences will be described.

In the example shown in FIG. 26, tracking is performed from a reference frame located first from the right to the base frame. However, an INTRA block exists in an I frame located third from the right, and therefore no motion vector exists, making it impossible to continue tracking. Therefore, first an imaginary motion vector MV is calculated using any one of the first to third correction methods shown in FIGS. 16B-16D, whereupon the tracking is continued using this MV. For example, when the third correction method of FIG. 16D is used, the imaginary motion vector MV is determined by determining the weighted average of MV1 and MV2 in FIG. 25.

After performing tracking to the next frame using MV and then continuing the tracking for one or more frames (two frames in the example of FIG. 25), an opposite direction motion vector MV5 corresponding to the imaginary motion vector MV is calculated by determining the weighted average of the motion vectors (MV3, MV4 in FIG. 25) of the one or more tracked frames. Opposite direction tracking is then performed from a P frame located second from the right to the I frame located third from the right using the opposite direction motion vector MV5, and when the position of the pixel tracked in the opposite direction matches the position of the original pixel (subject pixel), tracking is continued using the MV determined according to any one of the first to third correction methods finally as an imaginary motion vector. When the position of the tracked pixel does not match the position of the original pixel, “no motion vector” is set.

In this embodiment, an opposite direction motion vector is calculated by determining the weighted average of the motion vectors tracked up to that point, tracking is performed in an opposite direction using the opposite direction motion vector, and the imaginary motion vector is used for tracking only when a match is made with the original pixel. Therefore, tracking can be performed using only a highly precise imaginary motion vector. All other effects are identical to those of the image processing method and image processing apparatus according to the first embodiment.

### Sixth Embodiment

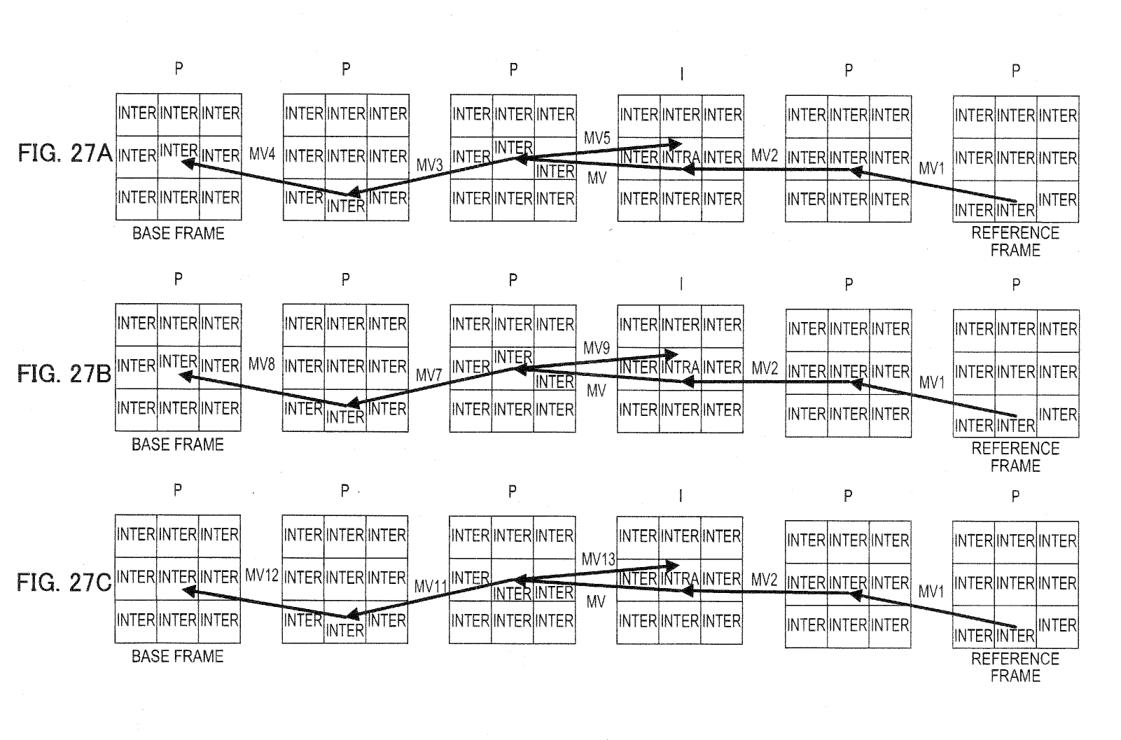

FIGS. 27A-27C are views showing correction methods employed during motion vector correction processing according to a sixth embodiment of this invention. Apart from the points to be described below, the constitution of the image processing apparatus and the content of the image processing method according to this embodiment are identical to those of the image processing apparatus and image processing method according to the first embodiment, and therefore only the differences will be described.

In the examples shown in FIGS. 27A-27C, tracking is performed from a reference frame located first from the right to the base frame. However, an INTRA block exists in an I frame located third from the right, and therefore no motion vector exists, making it impossible to continue tracking. Therefore, first, three imaginary motion vectors MV are calculated using the first to third correction methods shown in FIG. 16, whereupon tracking is continued using the respective MVs. In the example shown in FIG. 27A, the imaginary motion vector is set at 0 using the first correction method of FIG. 16B. In the example shown in FIG. 27B, the imaginary motion vector MV is calculated by determining the weighted average of the motion vectors of the peripheral blocks using the second correction method of FIG. 16C. In the example shown in FIG. 27C, the imaginary motion vector MV is determined by determining the weighted average of MV1 and MV2 in FIG. 25 using the third correction method of FIG. 16D.

After performing tracking to the next frame using the respective MVs and then continuing the tracking for one or more frames (two frames in the example of FIG. 25), opposite direction motion vectors MV5, MV9, MV13 corresponding respectively to the imaginary motion vectors MV are calculated by determining the weighted average of the motion vectors of the one or more tracked frames. In this case, MV5, MV9 and MV13 are calculated by determining the respective weighted averages of MV3 and MV4 in FIG. 27A, MV7 and MV8 in FIG. 27B, and MV11 and MV12 in FIG. 27C from the one or more tracked frames.

Opposite direction tracking is then performed from a P frame located second from the right to the I frame located third from the right using the opposite direction motion vectors MV5, MV9, MV13, whereupon opposite direction motion vectors MV5, MV9, MV13 in which the position of the pixel tracked in the opposite direction matches the position of the original pixel (subject pixel) are searched for. Tracking is then continued using the MV for which a matching opposite direction motion vector is found finally as an imaginary motion vector. When the position of the tracked pixel does not match the position of the original pixel, “no motion vector” is set.

In this embodiment, opposite direction motion vectors are calculated by determining the weighted average of the motion vectors tracked up to that point using all three of the first to third correction methods, tracking is performed in an opposite direction using the three opposite direction motion vectors, and an imaginary motion vector for which a match is made with the original pixel is used finally for tracking as the imaginary motion vector. Therefore, tracking can be performed by selecting a highly precise imaginary motion vector. All other effects are identical to those of the image processing method and image processing apparatus according to the first embodiment.

### Seventh Embodiment

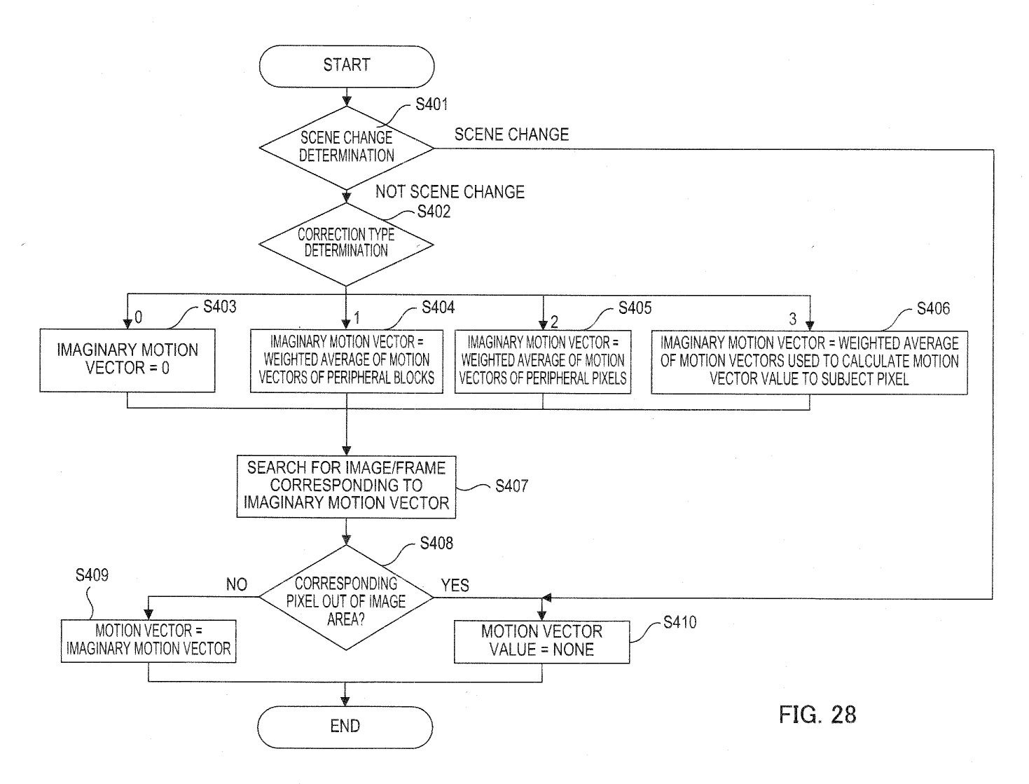

FIG. 28 is a flowchart showing the content of motion vector correction processing according to a seventh embodiment of this invention. The motion vector correction processing shown in FIG. 28 is performed as the motion vector correction processing (see S27, FIG. 7) of the motion vector calculation processing (see S104, FIG. 2) according to the first embodiment. Apart from the points to be described below, the constitution of the image processing apparatus and the content of the image processing method according to this embodiment are identical to those of the image processing apparatus and image processing method according to the first embodiment, and therefore only the differences will be described.

In the motion vector correction processing according to this embodiment, first, a scene change determination (S401) is performed by determining whether or not a frame including a tracking destination pixel (the pixel corresponding to the subject pixel) is an INTRA encoded frame that contradicts GOP structure setting. In the scene change determination (S401), a determination is made as to whether or not the frame is an INTRA encoded frame corresponding to a scene change by determining the encoding type on the basis of data recorded in moving image data including motion information encoded in MPEG or the like. When an INTRA encoded frame corresponding to a scene change is determined, “no motion vector” (S410) is set, and when an INTRA encoded frame corresponding to a scene change is not determined, an imaginary motion vector is calculated using processing of S402 onward.

When it is determined in the scene change determination (S401) that the frame including the tracking destination pixel is not an INTRA encoded frame corresponding to a scene change, a motion vector correction type is determined (S402), whereupon different imaginary motion vectors are calculated for each correction type. The correction types may be set through user input, for example, or may be set in advance in accordance with maker parameters and the like.

In this embodiment, when the correction type is 0, the imaginary motion vector is set at 0 (S403). When the correction type is 1, the imaginary motion vector is calculated by determining the weighted average of the motion vectors included in the peripheral blocks of the subject pixel (S404). When the correction type is 2, the imaginary motion vector is calculated by determining the weighted average of the motion vectors included in the peripheral pixels of the subject pixel (S405). When the correction type is 3, the imaginary motion vector is calculated by determining the weighted average of the motion vectors used to calculate the motion vector value from a pixel of the reference frame to the subject pixel (S406). Tracking is then performed using the imaginary motion vector calculated in S403 to S406, whereupon a pixel corresponding to a tracking destination subject pixel and a frame to which the pixel belongs are searched for (S407) and a determination is made as to whether or not the pixel corresponding to the subject pixel is outside of the image area (S408). When the pixel corresponding to the subject pixel is within the image area, the imaginary motion vector is set as the motion vector (S409), and when the pixel corresponding to the subject pixel is not within the image area, “no motion vector value” is set (S410).

In this embodiment, the scene change determination (S401) is performed to determine whether or not the frame including the tracking destination pixel is an INTRA encoded frame corresponding to a scene change, and therefore imaginary motion vector calculation in relation to a post-scene change frame that cannot be tracked may be omitted. When an INTRA encoded frame corresponding to a scene change is not determined, on the other hand, tracking can be performed using an imaginary motion vector. All other effects are identical to those of the image processing method and image processing apparatus according to the first embodiment.

This invention is not limited to the embodiments described above, and includes various modifications and improvements within the scope of the technical spirit thereof. For example, in the above embodiments, the position alignment processing unit 16 and the high-resolution image generation unit 18 of the image processing apparatus 1 are provided separately but may be provided integrally. Furthermore, the constitution of the image processing apparatus 1 is not limited to that shown in FIG. 1. Moreover, in the above embodiments, high-resolution image generation processing (S106) through super-resolution processing is performed by the high-resolution image generation unit 18, but resolution improvement processing other than super-resolution processing may be performed.

Further, in the embodiments described above, it is assumed that the processing performed by the image processing apparatus is hardware processing, but this invention is not limited to the constitution, and the processing may be performed using separate software, for example.

In this case, the image processing apparatus includes a CPU, a main storage device such as a RAM, and a computer readable storage medium storing a program for realizing all or a part of the processing described above. Here, the program will be referred to as an image processing program. The CPU realizes similar processing to that of the image processing apparatus described above by reading the image processing program stored on the storage medium and executing information processing and calculation processing.

Here, the computer readable storage medium is a magnetic disk, a magneto-optical disk, a CD-ROM, a DVD-ROM, a semiconductor memory, or similar. Further, the image processing program may be distributed to a computer over a communication line such that the computer, having received the distributed program, executes the image processing program.

What is claimed is:

1. An image processing method that uses an inter-frame image motion vector recorded in encoded moving image data, comprising:
a frame selection step for selecting a plurality of frames from frame images obtained by decoding the encoded moving image data;
a motion vector calculation step for calculating a motion vector value from one frame image to another frame image of the plurality of frame images selected in the frame selection step by tracking each pixel of one or a plurality of frame images using the motion vector recorded in the encoded moving image data; and
a motion vector correction step for calculating an imaginary motion vector from a pixel tracked up to a midway point to a tracking destination pixel corresponding to the pixel tracked up to the midway point when a motion vector that can be tracked to the tracking destination pixel does not exist in the motion vector calculation step due to an encoding type of a block including the pixel tracked up to the midway point.

2. The image processing method as defined in claim 1, wherein, in the motion vector calculation step, the inter-frame image motion vector recorded in the moving image data is accumulated taking direction into account such that the motion vector value from the one frame image to the other frame image is calculated for each pixel.

3. The image processing method as defined in claim 2, wherein, in the frame selection step, a base frame and a reference frame are selected as the plurality of frame images, and in the motion vector calculation step, a motion vector value from the reference frame to the base frame is calculated for each pixel.

4. The image processing method as defined in claim 3, further comprising a position alignment step for aligning the base frame and the reference frame on the basis of the motion vector value calculated in the motion vector calculation step.

5. The image processing method as defined in claim 4, further comprising a high-resolution image generation step for generating a high-resolution image having a higher resolution than the frame image using the base frame and the reference frame aligned in the position alignment step.

6. The image processing method as defined in claim 1, wherein, when a traceable motion vector does not exist in the motion vector correction step, the imaginary motion vector from the pixel tracked up to the midway point to the tracking destination pixel is set at 0.

7. The image processing method as defined in claim 1, wherein, when a traceable motion vector does not exist in the motion vector correction step, the imaginary motion vector from the pixel tracked up to the midway point to the tracking destination pixel is calculated by determining a weighted average of motion vectors of peripheral blocks of the pixel tracked up to the midway point or peripheral pixels of the pixel tracked up to the midway point.

8. The image processing method as defined in claim 1, wherein, when a traceable motion vector does not exist in the motion vector correction step, the imaginary motion vector from the pixel tracked up to the midway point to the tracking destination pixel is calculated by determining a weighted average of motion vectors used to calculate a motion vector value from a pixel of the one frame image to the pixel tracked up to the midway point.

9. The image processing method as defined in claim 1, wherein, when a traceable motion vector does not exist in the motion vector correction step, the imaginary motion vector from the pixel tracked up to the midway point to the tracking destination pixel is calculated by any of a first correction method in which the imaginary motion vector is set at 0, a second correction method in which a weighted average of motion vectors of peripheral blocks of the pixel tracked up to the midway point or peripheral pixels of the pixel tracked up to the midway point is determined, and a third correction method in which a weighted average of motion vectors used to calculate a motion vector value from a pixel of the one frame image to the pixel tracked up to the midway point is determined, and tracking is continued using the imaginary motion vector, and
after tracking has continued for one or more frames, the imaginary motion vector is updated using a motion vector of the one or more tracked frames, the updating operation being repeated at least once.

10. The image processing method as defined in claim 1, wherein, when a traceable motion vector does not exist in the motion vector correction step, the imaginary motion vector from the pixel tracked up to the midway point to the tracking destination pixel is calculated by any of a first correction method in which the imaginary motion vector is set at 0, a second correction method in which a weighted average of motion vectors of peripheral blocks of the pixel tracked up to the midway point or peripheral pixels of the pixel tracked up to the midway point is determined, and a third correction method in which a weighted average of motion vectors used to calculate the motion vector value from a pixel of the one frame image to the pixel tracked up to the midway point is determined, and tracking is continued using the imaginary motion vector, and
after tracking has continued for one or more frames, an inter-frame image opposite direction motion vector corresponding to the imaginary motion vector is calculated by determining a weighted average of motion vectors of the one or more tracked frames, tracking is performed in an opposite direction from the tracking destination pixel to the pixel tracked up to the midway point using the opposite direction motion vector, and when a match is made between a position of a pixel tracked in the opposite direction and a position of the pixel tracked up to the midway point, the imaginary motion vector calculated using one of the first to third correction methods is used finally to track the pixel tracked up to the midway point to the tracking destination pixel.

11. The image processing method as defined in claim 1, wherein, when a traceable motion vector does not exist in the motion vector correction step, the imaginary motion vector from the pixel tracked up to the midway point to the tracking destination pixel is calculated by each of a first correction method in which the imaginary motion vector is set at 0, a second correction method in which a weighted average of motion vectors of peripheral blocks of the pixel tracked up to the midway point or peripheral pixels of the pixel tracked up to the midway point is determined, and a third correction method in which a weighted average of motion vectors used to calculate the motion vector value from a pixel of the one frame image to the pixel tracked up to the midway point is determined, and tracking is continued using the imaginary motion vectors, and
after tracking has continued for one or more frames, an inter-frame image opposite direction motion vector corresponding to the imaginary motion vector is calculated by determining a weighted average of motion vectors of the one or more tracked frames, tracking is performed in an opposite direction from the tracking destination pixel to the pixel tracked up to a midway point using the opposite direction motion vector, and when a match is made between a position of a pixel tracked in the opposite direction and a position of the pixel tracked up to the midway point, the imaginary motion vector for which the position of the pixel tracked in the opposite direction matches the position of the pixel tracked up to the midway point, from among the imaginary motion vectors calculated respectively using the first to third correction methods, is used finally to track the pixel tracked up to the midway point to the tracking destination pixel.

12. The image processing method as defined in claim 1, wherein, when a traceable motion vector does not exist in the motion vector correction step, an encoding type determination is performed to determine whether or not the block including the pixel tracked up to the midway point is an INTRA-encoded block in an INTRA-encoded frame corresponding to a scene change on the basis of data recorded in the encoded moving image data, and when the block including the pixel tracked up to the midway point is not an INTRA-encoded block in an INTRA-encoded frame corresponding to a scene change, the imaginary motion vector is calculated.

13. An image processing apparatus that uses an inter-frame image motion vector recorded in encoded moving image data, comprising:
a frame selection unit which selects a base frame and a reference frame from frame images obtained by decoding the encoded moving image data; and
a motion vector calculation unit which calculates a motion vector value from the reference frame to the base frame by accumulating a motion vector recorded in the encoded moving image data taking direction into account so as to track each pixel of one or a plurality of frame images,
wherein the motion vector calculation unit includes a motion vector correction unit which calculates an imaginary motion vector from a pixel tracked up to a midway point to a tracking destination pixel corresponding to the pixel tracked up to the midway point when a motion vector that can be tracked to the tracking destination pixel does not exist due to an encoding type of a block including the pixel tracked up to the midway point.

14. A computer readable storage medium stored with a computer program for causing a computer to execute image processing that uses an inter-frame image motion vector recorded in encoded moving image data, wherein the computer program comprises:
a frame selection step for selecting a plurality of frames from frame images obtained by decoding the encoded moving image data;
a motion vector calculation step for calculating a motion vector value from one frame image to another frame image of the plurality of frame images selected in the frame selection step by tracking each pixel of one or a plurality of frame images using the motion vector recorded in the encoded moving image data; and
a motion vector correction step for calculating an imaginary motion vector from a pixel tracked up to a midway point to a tracking destination pixel corresponding to the pixel tracked up to the midway point when a motion vector that can be tracked to the tracking destination pixel does not exist in the motion vector calculation step due to an encoding type of a block including the pixel tracked up to the midway point.
